(19) United States
(12) Patent Application Publication
(10) Pub. No.: US 2025/0361129 A1
(43) Pub. Date: Nov. 27, 2025

(54) BATTERY SWAPPING DEVICE AND ASSEMBLING METHOD THEREFOR

(71) Applicants: AULTON NEW ENERGY CO., LTD., Guangzhou (CN); SHANGHAI DIANBA NEW ENERGY TECHNOLOGY CO., LTD., Shanghai (CN)

(72) Inventors: Jianping Zhang, Shanghai (CN); Xinrui Yu, Shanghai (CN); Kaifeng Wang, Shanghai (CN); Zhiqiang Song, Shanghai (CN); Huiqin Ji, Shanghai (CN); Ming Zhu, Shanghai (CN); Bo Ni, Shanghai (CN)

(21) Appl. No.: 19/223,355

(22) Filed: May 30, 2025

Related U.S. Application Data
(63) Continuation of application No. PCT/CN2023/134871, filed on Nov. 28, 2023.

(30) Foreign Application Priority Data
Dec. 1, 2022 (CN) 202211539297.X

(51) Int. Cl. B66F 9/065; B60L 53/80; H01M 50/249

(52) U.S. Cl. CPC B66F 9/065; B60L 53/80; H01M 50/249; H01M 2220/20

(57) ABSTRACT

A battery swapping device and an assembling method therefor are provided. The battery swapping device can walk in a preset track to perform chassis-type battery swapping on a battery swapping vehicle. The battery swapping device comprises a battery swapping module, a first walking module and a second walking module, wherein the battery swapping module comprises a frame body, a lifting mechanism and a battery swapping platform; the first walking module is connected to one side of the battery swapping module in the walking direction of the battery swapping device; the first walking module comprises a rotationally-connected first walking wheel set; the second walking module is connected to the other side of the battery swapping module in the walking direction and is opposite to the first walking module; and the second walking module comprises two slidably-connected second walking wheel sets.

### CROSS-REFERENCE TO RELATED APPLICATIONS

The present application is a continuation application of PCT application No. PCT/CN2023/134871 filed on Nov. 28, 2023, which claims the benefit of Chinese Patent Application No. 202211539297.X filed on Dec. 1, 2022. The contents of all of the aforementioned applications are incorporated by reference herein in their entirety.

### TECHNICAL FIELD

The present disclosure relates to the technical field of battery swapping devices, in particular to a battery swapping device and an assembling method therefor.

### BACKGROUND

Batteries of the existing battery swapping vehicles are generally mounted in two types: a fixed type and a swappable type. A movable mounting manner is generally adopted for the swappable batteries, wherein batteries can be removed at any time for swapping or charging, and then the batteries are mounted on a vehicle body after swapping or charging is completed.

When a battery pack of a battery swapping vehicle is swapped in a battery swapping station, the battery swapping device needs to be accurately positioned relative to the battery swapping vehicle, to ensure that the battery pack can be smoothly disassembled and mounted by the battery swapping device. However, the existing battery swapping device basically travels in a track perpendicular to the walking direction of the battery swapping vehicle, and can only adjust its position in the extension direction of the track and the extension direction perpendicular to the track. If the battery swapping vehicle is tilted at a certain angle relative to its traveling direction, the battery swapping device may not be accurately positioned relative to the battery swapping vehicle, thereby resulting in failure in smooth disassembly and mounting of the battery pack. In addition, due to its large weight and volume, it is difficult for the battery swapping vehicle to be parked in an accurate position with a precise posture, especially for heavy trucks. Therefore, the battery swapping device needs to be adjusted to accurately position relative to the battery swapping vehicle.

### SUMMARY

The technical problem to be solved by the present disclosure is to overcome the defect in the prior art that the battery swapping device fails to correspond to the battery swapping vehicle due to improper parking of the battery swapping vehicle, making it difficult to position and swap the battery, and to provide a battery swapping device and an assembling method therefor.

The present disclosure solves the above technical problems through the following technical solutions:

A battery swapping device can walk in a preset track to perform chassis-type battery swapping for a battery swapping vehicle, and the battery swapping device includes:
a battery swapping module including a frame body, a lifting mechanism and a battery swapping platform, wherein the frame body includes two opposing transverse beams and two opposing longitudinal beams arranged to enclose a space, and two partition plates parallel to the longitudinal beams and connected to the transverse beams, the partition plates divide the frame body into a central zone and side zones symmetrically arranged on both sides of the central zone, the lifting mechanism is connected to the partition plates, the lifting mechanism is partially located in the side zones and partially located in the central zone, and the battery swapping platform is arranged in the central zone and connected to the lifting mechanism, such that the battery swapping platform can be lifted by the lifting mechanism and can rise and fall relative to the frame body to swap batteries for the battery swapping vehicle;
a first walking module connected to a side of the battery swapping module in the walking direction of the battery swapping device, wherein the first walking module includes at least one first walking wheel set that is rotatably connected; and
a second walking module connected to the other side of the battery swapping module in the walking direction and opposite to the first walking module, wherein the second walking module includes at least two second walking wheel sets that are slidably connected;
wherein when the second walking wheel set is driven, the battery swapping module can rotate in a horizontal plane with the first walking wheel set as a fulcrum to align with the battery of the battery swapping vehicle.

In this solution, with the above structural form, the battery swapping device is modularized, to facilitate the mounting of required components on each module of the battery swapping device, improve the mounting efficiency, and shorten the production cycle of each module, meanwhile, the staff can conveniently disassemble and repair, thereby enhancing the flexibility and extensiveness of the application of the battery swapping device and making the battery swapping device more applicable. A first walking module and a second walking module are respectively arranged on both sides of the battery swapping module, and a lifting mechanism is adopted to drive the battery swapping platform, to facilitate independent operation of each mechanism and ensure that the battery swapping device can enter from the bottom of the battery swapping vehicle to ensure safety of battery swapping of the battery swapping vehicle. At the same time, the battery swapping module can rotate in a horizontal plane with the first walking wheel set as the fulcrum, such that when the parking position of the battery swapping vehicle is deviated, the battery swapping device can achieve precise positioning with the battery swapping vehicle through rotation, thereby ensuring the accuracy of battery swapping and improving the efficiency of battery swapping.

An assembling method for a battery swapping device is applicable to the above battery swapping device, and the assembling method includes the following steps:
mounting the lifting mechanism and the battery swapping platform in the frame body to form a battery swapping module;
assembling the first walking wheel set to form a first walking module;
assembling the second walking wheel set to form a second walking module; and
respectively mounting the first walking module and the second walking module on both sides of the battery swapping module in a walking direction to form the battery swapping device.

In this solution, the battery swapping device is assembled in a modular manner. Since the overall structure of each module is small, the modules are easily assembled; and the required corresponding mechanisms are assembled into each module respectively, to reduce the complexity of assembly and the possibility of errors. At the same time, the modules can be assembled according to the connection relationship and position relationship between the modules. The staff can assemble the modules as needed according to the actual situation, thereby enhancing the flexibility of assembling and debugging a single module. Further, after mounting the other components in the corresponding modules according to the actual situation, the modules are assembled according to the connection relationship and position relationship between the components in each module, such that the space occupied by on-site assembly before the modules are assembled can be saved.

The positive and progressive effects of the present disclosure are as follows:

In the present disclosure, the battery swapping device is modularized, to facilitate the mounting of required components on each module of the battery swapping device, improve mounting efficiency, and shorten the production cycle of each module, meanwhile, the staff can conveniently disassemble and repair, thereby enhancing the flexibility and extensiveness of the application of the battery swapping device and making the battery swapping device more applicable. A first walking module and a second walking module are respectively arranged on both sides of the battery swapping module, and a lifting mechanism is adopted to drive the battery swapping platform, to facilitate independent operation of each mechanism and ensure that the battery swapping device can enter from the bottom of the battery swapping vehicle to ensure safety of battery swapping of the battery swapping vehicle. At the same time, the battery swapping module can rotate in a horizontal plane with the first walking wheel set as the fulcrum, such that when the parking position of the battery swapping vehicle is deviated, the battery swapping device can achieve precise positioning with the battery swapping vehicle through rotation, thereby ensuring the accuracy of battery swapping and improving the efficiency of battery swapping.

### BRIEF DESCRIPTION OF THE DRAWINGS

FIG. 1 is a schematic diagram of the three-dimensional structure of a battery swapping device and a preset track according to Embodiment 1 of the present disclosure.

FIG. 2 is a schematic diagram of the three-dimensional structure of the battery swapping device according to Embodiment 1 of the present disclosure (a first layer plate and a second layer plate are hidden in the figure).

FIG. 3 is a schematic diagram of the three-dimensional structure of a first walking module of the battery swapping device according to Embodiment 1 of the present disclosure.

FIG. 4 is a schematic diagram of the three-dimensional structure of a first walking wheel set of the battery swapping device according to Embodiment 1 of the present disclosure.

FIG. 5 is a schematic diagram of the three-dimensional structure of a third walking wheel set of the battery swapping device according to Embodiment 1 of the present disclosure.

FIG. 6 is a schematic diagram of the three-dimensional structure of a second walking module of the battery swapping device according to Embodiment 1 of the present disclosure.

FIG. 7 is a schematic diagram of a cross-sectional structure of a second sliding assembly and a second rotating assembly of the second walking module of the battery swapping device according to Embodiment 1 of the present disclosure.

FIG. 8 is a schematic diagram of the three-dimensional structure of wheels and a walking maintenance mechanism of the battery swapping device according to Embodiment 1 of the present disclosure.

FIG. 9 is a schematic diagram of the three-dimensional structure of the walking maintenance mechanism and the preset track of the battery swapping device according to Embodiment 1 of the present disclosure.

FIG. 10 is a schematic diagram of the three-dimensional structure of a frame body of the battery swapping device according to Embodiment 1 of the present disclosure.

FIG. 11 is a schematic diagram of the three-dimensional structure of a lifting mechanism of the battery swapping device according to Embodiment 1 of the present disclosure.

FIG. 12 is a schematic diagram of the three-dimensional structure of a transmission assembly of the lifting mechanism of the battery swapping device according to Embodiment 1 of the present disclosure.

FIG. 13 is a schematic diagram of a top view of a connecting portion of the battery swapping device according to Embodiment 1 of the present disclosure.

FIG. 14 is a schematic diagram of the three-dimensional structure of a guide member of the battery swapping device according to Embodiment 1 of the present disclosure.

FIG. 15 is a schematic diagram of the three-dimensional structure of a guide mechanism and a moving mechanism of the battery swapping platform of the battery swapping device according to Embodiment 1 of the present disclosure.

FIG. 16 is a schematic diagram of the three-dimensional structure of a first layer plate of the battery swapping platform of the battery swapping device according to Embodiment 1 of the present disclosure.

FIG. 17 is a schematic diagram of the three-dimensional structure of a second layer plate of the battery swapping platform of the battery swapping device according to Embodiment 1 of the present disclosure.

FIG. 18 is a flow chart of an assembling method for the battery swapping device according to Embodiment 2 of the present disclosure.

FIG. 19 is a schematic diagram of the three-dimensional structure of the battery swapping device according to Embodiment 3 of the present disclosure.

FIG. 20 is a schematic diagram of the three-dimensional structure of a grooved wheel according to Embodiment 3 of the present disclosure.

FIG. 21 is a schematic diagram of the three-dimensional structure of a second walking module according to Embodiment 3 of the present disclosure.

FIG. 22 is a schematic diagram of the three-dimensional structure of a stopping assembly according to Embodiment 3 of the present disclosure.

FIG. 23 is a schematic diagram of the three-dimensional structure of a first connecting seat connected to the first walking wheel set according to Embodiment 3 of the present disclosure.

### DETAILED DESCRIPTION OF THE EMBODIMENTS

The present disclosure will be described more clearly and completely below by way of embodiments and in conjunction with the accompanying drawings, but the present disclosure is not limited to the scope of the embodiments.

### Embodiment 1

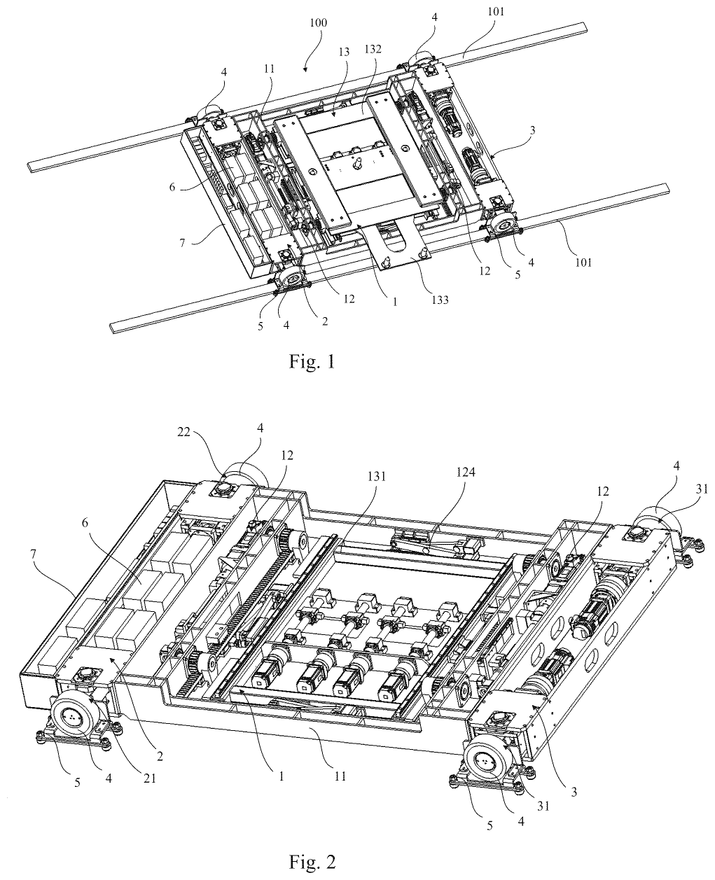

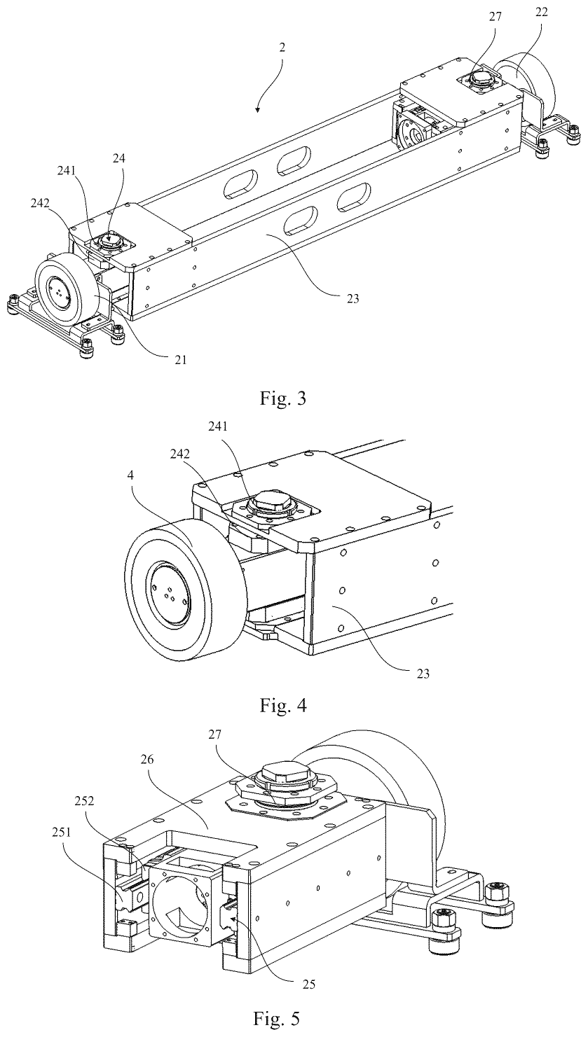

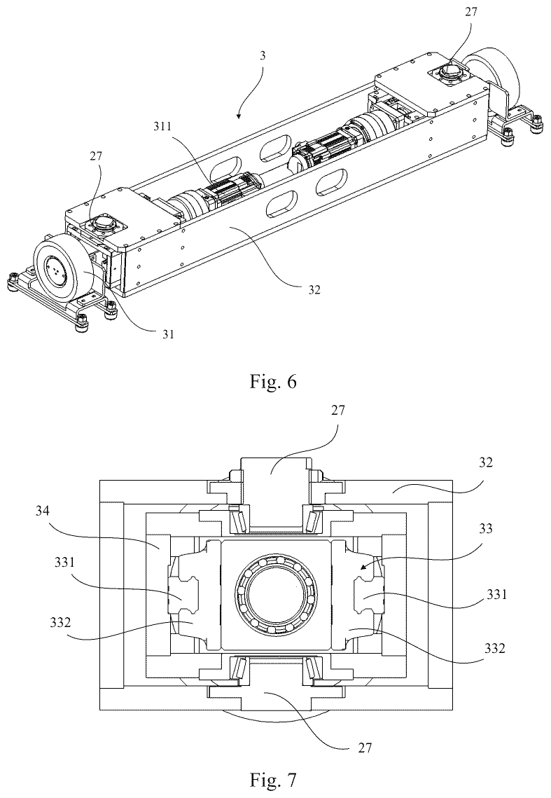

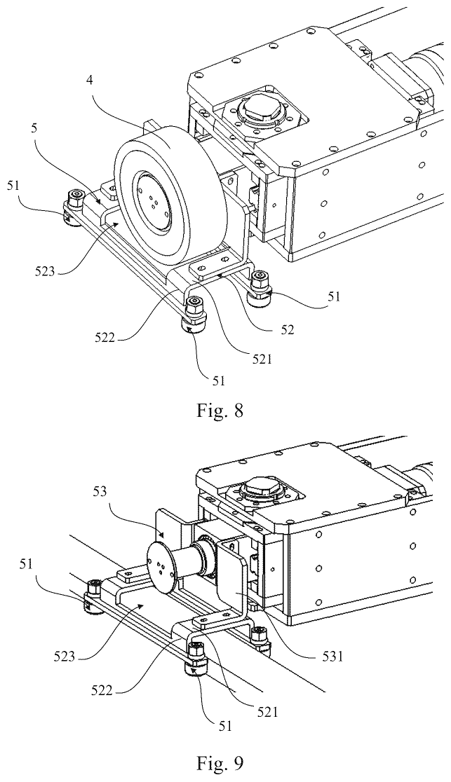

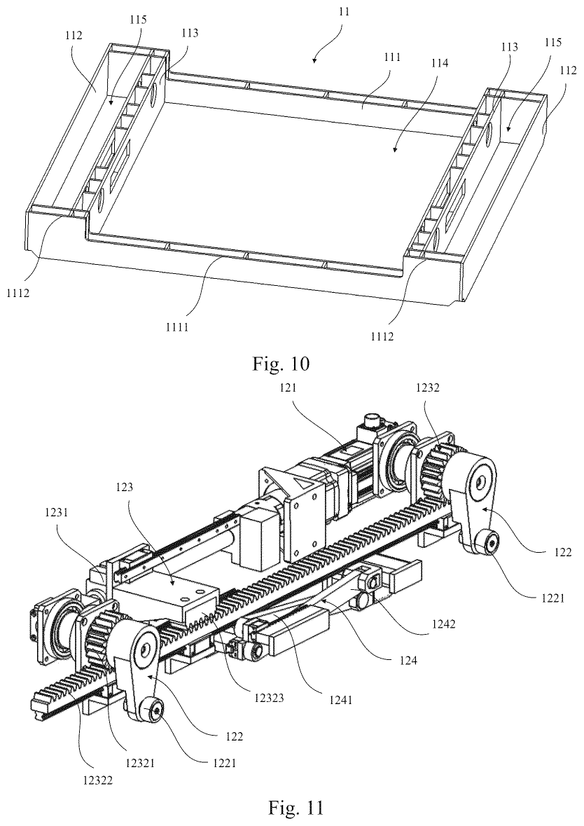

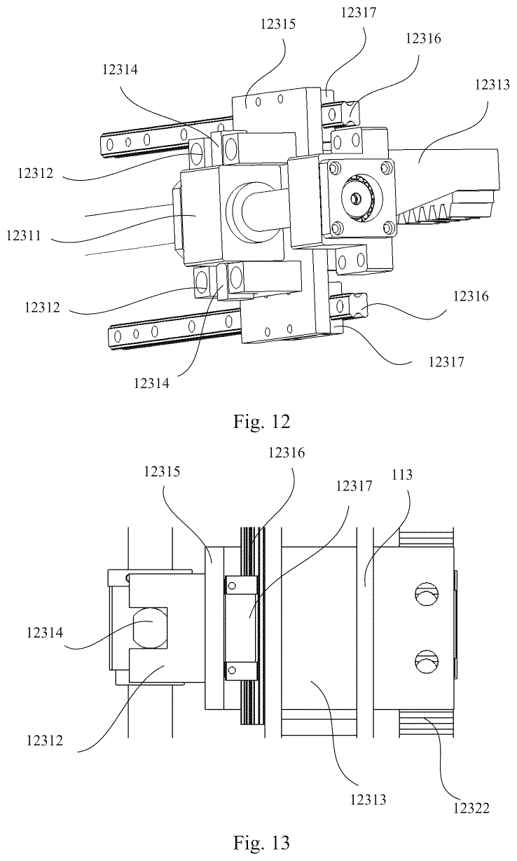

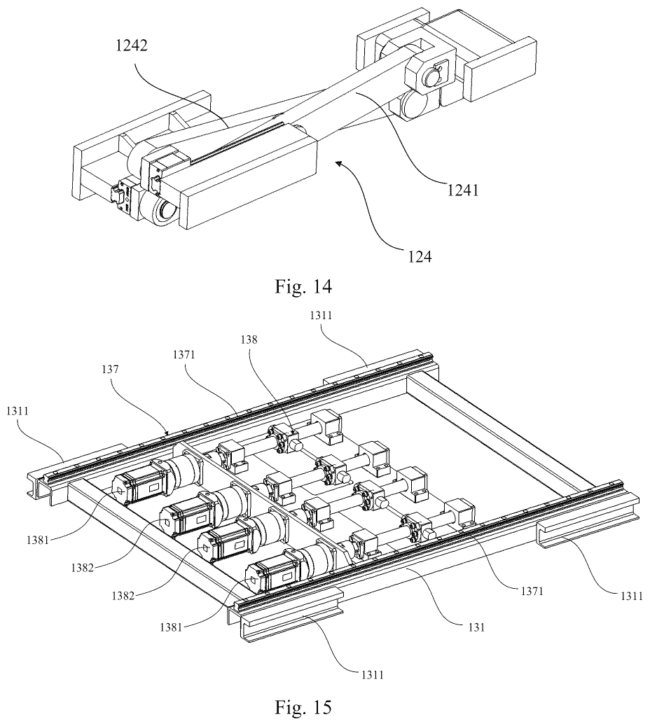

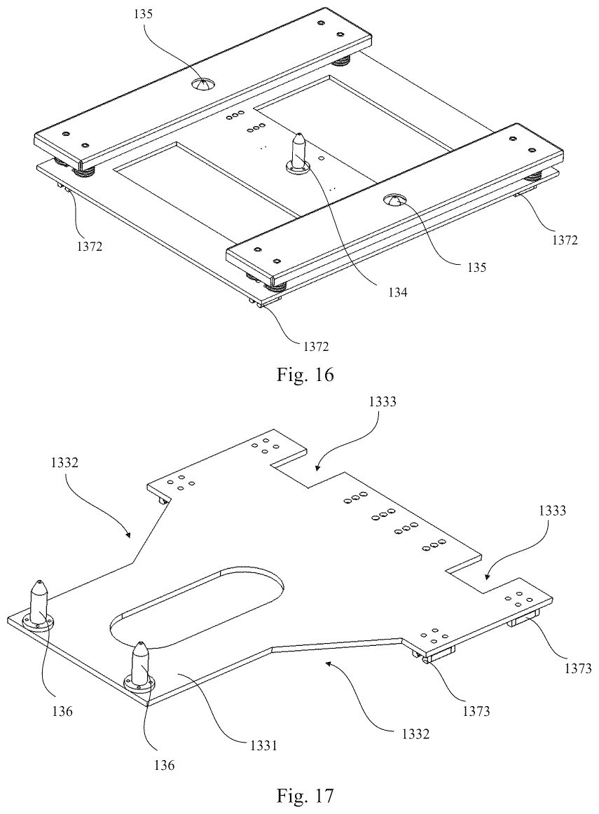

As shown in FIGS. 1 to 17, this embodiment provides a battery swapping device 100, and the battery swapping device 100 can walk in a preset track 101 to perform chassis-type battery swapping for a battery swapping vehicle. The battery swapping device 100 includes a battery swapping module 1, a first walking module 2 and a second walking module 3, wherein the battery swapping module 1 includes a frame body 11, a lifting mechanism 12 and a battery swapping platform 13; the frame body 11 includes two opposing transverse beams 111 and two opposing longitudinal beams 112 arranged to enclose a space, and two partition plates 113 parallel to the longitudinal beams 112 and connected to the transverse beams 111; the partition plates 113 divide the frame body 11 into a central zone 114 and side zones 115 symmetrically arranged on both sides of the central zone 114; the lifting mechanism 12 is connected to the partition plates 113, and the lifting mechanism 12 is partially located in the side zones 115 and partially located in the central zone 114, and the battery swapping platform 13 is arranged in the central zone 114 and connected to the lifting mechanism 12, such that the battery swapping platform 13 can be lifted by the lifting mechanism 12 and can rise and fall relative to the frame body 11 to swap batteries for the battery swapping vehicle. The first walking module 2 is connected to a side of the battery swapping module 1 in the walking direction of the battery swapping device 100, wherein the first walking module 2 includes a first walking wheel set 21 that is rotatably connected; and the second walking module 3 is connected to the other side of the battery swapping module 1 in the walking direction and opposite to the first walking module 2, wherein the second walking module 3 includes two second walking wheel sets 31 that are slidably connected, wherein when the second walking wheel set 31 is driven, the battery swapping module 1 can rotate in a horizontal plane with the first walking wheel set 21 as a fulcrum to align with the battery of the battery swapping vehicle. Specifically, in this embodiment, the transverse beam 111 and the partition plate 113 are both provided with double-layer plates, and an interval space is formed between the double-layer plates. The interval space between the double-layer plates of the partition plate 113 can facilitate the connection of components such as the lifting mechanism 12 with the partition plate 113, and the interval space of the double-layer plates of the transverse beam 111 can reserve a space for the wiring inside the battery swapping device 100, thereby facilitating connection of various electrical elements inside the battery swapping device 100 to high-voltage or low-voltage cables, increasing the structural compactness of the battery swapping device 100, and ensuring the neatness and reliability of the cables. In other optional embodiments, the transverse beam 111 and the partition plate 113 can also be set as a single-layer plate or a plate structure with more than two layers.

With the above structural form, the battery swapping device 100 is modularized, to facilitate the mounting of required components on each module of the battery swapping device 100, improve mounting efficiency, and shorten the production cycle of each module, meanwhile, the staff can conveniently disassemble and repair, thereby enhancing the flexibility and extensiveness of the application of the battery swapping device 100 and making the battery swapping device 100 more applicable. The first walking module 2 and the second walking module 3 are respectively arranged on both sides of the battery swapping module 1, and the lifting mechanism 12 is adopted to drive the battery swapping platform 13, to facilitate independent operation of each mechanism and ensure that the battery swapping device 100 can enter from the bottom of the battery swapping vehicle to ensure safety of battery swapping of the battery swapping vehicle. At the same time, the battery swapping module 1 can rotate in a horizontal plane with the first walking wheel set 21 as the fulcrum, such that when the parking position of the battery swapping vehicle is deviated, the battery swapping device 100 can adjust its posture through rotation to achieve precise positioning with the battery swapping vehicle, thereby ensuring the accuracy of battery swapping and improving the efficiency of battery swapping. Wherein, the walking direction of the battery swapping device 100 is just the length extension direction of the preset track 101 in FIG. 1.

In some embodiments, the first walking module 2 includes only one first walking wheel set 21, and the first walking wheel set 21 can be arranged on a central axis of the battery swapping device 100 in the walking direction. The two second walking wheel sets 31 of the second walking module 3 are arranged on both sides of the battery swapping device 100 in the walking direction, such that the three walking wheel sets stably support the battery swapping device 100 in a triangular shape, and such functions as walking and rotating can be realized.

In this embodiment, the first walking module 2 also includes a third walking wheel set 22, and the first walking wheel set 21 and the third walking wheel set 22 are oppositely arranged on both sides of the battery swapping device 100 parallel to the walking direction. The two second walking wheel sets 31 are oppositely arranged on both sides of the battery swapping device 100 parallel to the walking direction, that is, the four walking wheel sets are respectively located at four end corners of the battery swapping device 100, such that the battery swapping device 100 is stably supported, to ensure the walking smoothness of the battery swapping device 100 and improve the carrying capacity of the battery swapping device 100.

In this embodiment, the two second walking wheel sets 31 are independently provided with a driving mechanism 311 to increase the driving force of the battery swapping device 100. Especially during the walking process of the battery swapping device 100, the two driving mechanisms 311 synchronously drive the two second walking wheel sets 31, such that the battery swapping device 100 can walk fast and stably. At the same time, when the battery swapping device 100 needs to adjust its posture to align with the battery pack of the battery swapping vehicle, one of the second walking wheel sets 31 can be driven to move slightly in the preset track 101. Since the battery swapping device 100 always walks in the preset track 101, the second walking wheel set 31 will continue to maintain the walking direction when moving slightly and slide relative to the battery swapping device 100, thereby allowing the battery swapping device 100 to rotate in a horizontal plane with the first walking wheel set 21 as a fulcrum to achieve posture adjustment and adapt to some angular deviations that occur when the battery swapping vehicle is parked; or the two driving mechanisms 311 can simultaneously drive the two second walking wheel sets 31 in opposite directions, thereby applying a rotational torque to the battery swapping module 1 through the two second walking wheel sets 31, and allowing the battery swapping module 1 to rotate in a horizontal plane with the first walking wheel set 21 as a fulcrum. The two driving mechanisms 311 can be arranged to increase the rotational power of the battery swapping device 100 and expand the application scope of the battery swapping device 100. In other optional embodiments, a driving mechanism 311 can be also be arranged in only one of the second walking wheel sets 31. Preferably, the driving mechanism 311 is arranged in the second walking wheel set 31 which is located at a diagonal position relative to the first walking wheel set 21.

In this embodiment, the first walking module 2 further includes a first walking frame 23, and the second walking module 3 further includes a second walking frame 32. The first walking frame 23 and the second walking frame 32 are oppositely arranged on both sides of the vertical walking direction of the battery swapping module 1. The first walking wheel set 21 and the third walking wheel set 22 are respectively located on both sides of the first walking frame 23 in the walking direction, and the two second walking wheel sets 31 are respectively located on both sides of the second walking frame 32 in the walking direction. The first walking frame 23 and the second walking frame 32 are arranged to facilitate the mounting of the first walking wheel set 21, the second walking wheel set 31 and the third walking wheel set 22; neither the first walking wheel set 21 nor the third walking wheel set 22 needs to be provided with power components, and the two are arranged in the same walking frame, thereby saving the mounting space of the walking frame and allowing the mounting of other elements; and the two second walking wheel sets 31 are arranged in the same walking frame, to facilitate centralized mounting of the driving mechanism 311.

In this embodiment, the top and bottom of the first walking wheel set 21 are respectively connected to the first walking frame 23 through the first rotating assembly 24. The first rotating assembly 24 includes a fixed portion 241 and a rotating portion 242 that are configured to withstand a radial force and an axial force and are rotatably connected to each other, the fixed portion 241 is connected to the first walking frame 23, and the rotating portion 242 is connected to the top or bottom of the first walking wheel set 21. The rotational connection between the first walking frame 23 and the first walking wheel set 21 is achieved by the fixed portion 241 and the rotating portion 242 that are rotatably connected to each other. At the same time, since the fixed portion 241 and the rotating portion 242 can withstand a radial force and an axial force, the stability of the rotational connection can be better, thereby improving the walking stability of the first walking frame 23 and the stability of the rotation process of the battery swapping device 100. In other optional embodiments, the rotating portion 242 can also be connected to the first walking frame 23, and the fixed portion 241 can be connected to the top or bottom of the first walking wheel set 21. Specifically, in this embodiment, the first rotating assembly 24 adopts a tapered roller bearing. In other optional embodiments, the first rotating assembly 24 may also adopt other components capable of achieving a relative rotation function.

In this embodiment, the front side and the rear side of the third walking wheel set 22 in the walking direction are respectively connected to the first walking frame 23 through the first sliding assembly 25. The first sliding assembly 25 includes a first slide rail 251 and a first sliding block 252 that cooperate with each other, the first slide rail 251 is connected to the first walking frame 23 and extends in a direction perpendicular to the walking direction of the battery swapping device 100, and the first sliding block 252 is connected to the third walking wheel set 22, such that the sliding direction of the third walking wheel set 22 is correspondingly perpendicular to the walking direction of the battery swapping device 100. The front side and the rear side of the second walking wheel set 31 in the walking direction are respectively connected to the second walking frame 32 through the second sliding assembly 33, the second sliding assembly 33 includes a second slide rail 331 and a second sliding block 332 that cooperate with each other, the second slide rail 331 is connected to the second walking frame 32 and extends in a direction perpendicular to the walking direction of the battery swapping device 100, and the second sliding block 332 is connected to the second walking wheel set 31, such that the sliding direction of the second walking wheel set 31 is correspondingly perpendicular to the walking direction of the battery swapping device 100. The third walking wheel set 22 is slidably connected to the first walking frame 23 through the first sliding assembly 25, and the second walking wheel set 31 is slidably connected to the second walking frame 32 through the second sliding assembly 33, to provide a way to realize the displacement in the horizontal plane required for the battery swapping module 1 during rotation; and the cooperation between the first slide rail 251 and the first sliding block 252 and the cooperation between the second slide rail 331 and the second sliding block 332 make the sliding more stable. In other optional embodiments, the first sliding block 252 can also be connected to the first walking frame 23, the first slide rail 251 can be connected to the third walking wheel set 22, the second sliding block 332 can be connected to the second walking frame 32, and the second slide rail 331 can be connected to the second walking wheel set 31. Specifically, in this embodiment, the heights of the two first slide rails 251 and the first sliding blocks 252 on the front side and the rear side of the third walking wheel set 22 are correspondingly the same, and the heights of the two second slide rails 331 and the second sliding blocks 332 on the front side and the rear side of the second walking wheel set 31 are correspondingly the same, such that the force on the third walking wheel set 22 and the second walking wheel set 31 is more balanced and the operation is smoother, thereby avoiding the generation of an eccentric force due to different height settings, and influencing the movement stability of the battery swapping device 100.

In this embodiment, a first connecting seat 26 is also arranged in the first walking frame 23, the front side and the rear side of the third walking wheel set 22 are respectively connected to the first connecting seat 26 through the first sliding assembly 25, and the top and bottom of the first connecting seat 26 are respectively connected to the first walking frame 23 through the second rotating assembly 27; a second connecting seat 34 is also arranged in the second walking frame 32, the front side and the rear side of the second walking wheel set 31 are respectively connected to the second connecting seat 34 through the second sliding assembly 33, and the top and bottom of the second connecting seat 34 are respectively connected to the second walking frame 32 through the second rotating assembly 27. With the above structural form, the third walking wheel set 22 can slide relative to the first connecting seat 26, the second walking wheel set 31 can slide relative to the second connecting seat 34, and the first connecting seat 26 and the second connecting seat 34 can rotate relative to the first walking frame 23 and the second walking frame 32 respectively. In addition, the front side and the rear side of the third walking wheel set 22 are provided with the first sliding assembly 25, and the front side and the rear side of the second walking wheel set 31 are both provided with a second sliding assembly 33, such that the third walking wheel set 22 and the second walking wheel set 31 slide more stably, and the sliding is prevented from deviating from a preset sliding trajectory. The cooperation between sliding and rotation improves the stability and smoothness of the rotation of the battery swapping device 100 in a horizontal plane. Specifically, in this embodiment, a preset gap is formed between the first connecting seat 26 and the first walking frame 23 and between the second connecting seat 34 and the second walking frame 32 in the walking direction, so as to facilitate unobstructed rotation of each walking wheel set. Specifically, the preset gap is determined based on the rotation range of the battery swapping device relative to the first walking wheel set and the second walking wheel set during the design of the battery swapping device, so as to ensure that there is no interference between the first connecting seat 26 and the first walking frame 23 and there is no interference between the second connecting seat 34 and the second walking frame 32 during the rotation of the battery swapping device. The second rotating assembly 27 adopts a tapered roller bearing. In other optional embodiments, the second rotating assembly 27 may also adopt other components capable of achieving a relative rotation function. In addition, in this embodiment, except that the third walking wheel set 22 does not have a power component, the other structures are the same as the second walking wheel set 31.

In this embodiment, a locking mechanism having a locked state and an unlocked state is arranged on the second sliding assembly 33. When the locking mechanism is in the locked state, the locking mechanism can limit the relative sliding of the second sliding assembly 33, such that when the second walking wheel set 31 is driven, the second walking wheel set 31 can drive the battery swapping device 100 to walk in the preset track 101; when the locking mechanism is in the unlocked state, the second sliding assembly 33 can slide relatively, such that when the second walking wheel set 31 is driven, the second walking wheel set 31 moves by a preset distance in the preset track 101, and can drive the battery swapping device 100 to rotate in a horizontal plane with the first walking wheel set 21 as the fulcrum, such that the battery swapping module 1 is aligned with the battery of the battery swapping vehicle. During a process in which the battery swapping device 100 walks in the walking direction specified by the preset track 101 until the battery swapping device 100 is aligned with the battery of the battery swapping vehicle, the locking mechanism is in a locked state, that is, the second slide rail 331 and the second sliding block 332 of the second sliding assembly 33 cannot slide relative to each other, thereby preventing shaking of the battery swapping device 100 due to the sliding of the second sliding assembly 33 during an initial walking process, and improving the walking smoothness of the battery swapping device 100; after the battery swapping device 100 walks to the bottom of the battery swapping vehicle, the locking mechanism is changed to an unlocked state, such that the second slide rail 331 and the second sliding block 332 can slide relative to each other, and then the relative angle between the battery swapping device 100 and the battery swapping vehicle is adjusted.

In this embodiment, the locking mechanism includes a retractable locking rod. When the locking mechanism is in a locked state, the locking rod extends from an original position and abuts against the second slide rail 331 at a preset position to limit the relative movement of the second slide rail 331 and the second sliding block 332. When the locking mechanism is in an unlocked state, the locking rod retracts to the original position. The locking rod is set to be retractable, and the locking mechanism can be switched between the locked state and the unlocked state, thereby achieving the control over whether the second sliding assembly 33 can slide. When the locking rod extends and presses the second slide rail 331, the second sliding block 332 is prevented from sliding relative to the second slide rail 331 through a friction force.

In this embodiment, two locking rods are arranged, and the two locking rods are respectively arranged on the upper and lower sides of the second slide rail 331. Therefore, the telescopic direction of the locking rod points to the side of the second slide rail 331, and the shape of the end of the locking rod matches the shape of the side of the second slide rail 331. The two locking rods act on the second slide rail 331 from the upper and lower sides of the second slide rail 331, respectively, such that the two locking rods can clamp the second slide rail 331 during the locking process, the friction force is greater and the locking effect is better. Wherein the shape of the end of the locking rod matches the shape of the side of the second slide rail 331, thereby allowing more firm engagement between the locking rod and the second slide rail 331, further improving the locking effect of the locking rod, and preventing the locking rod from detaching from the second slide rail 331. In other optional embodiments, a locking hole for the locking rod to be inserted can also be arranged in the second slide rail 331 for locking. This structural form can further improve the reliability of limiting the sliding of the second sliding assembly 33.

In this embodiment, the first walking wheel set 21, the second walking wheel set 31 and the third walking wheel set 22 are all provided with wheels 4 that can walk in the preset track 101. The first walking wheel set 21, the second walking wheel set 31 and the third walking wheel set 22 are all connected with a walking maintenance mechanism 5. The walking maintenance mechanism 5 straddles the preset track 101, such that the wheels 4 of the first walking wheel set 21, the second walking wheel set 31 and the third walking wheel set 22 are limited to walk on the preset track 101. The above structural form is adopted to ensure that the wheels 4 of the first walking wheel set 21, the second walking wheel set 31 and the third walking wheel set 22 will not slip or deviate from the preset track 101 when moving in the preset track 101, thereby further ensuring the walking stability of the battery swapping device 100 and ensuring the walking route of the battery swapping device 100 to avoid deviation.

In this embodiment, the walking maintenance mechanism 5 includes a plurality of limiting portions 51 straddling both sides of the preset track 101 and a mounting portion 52 configured to mount the limiting portions 51. The mounting portion 52 straddles the preset track 101 in the width direction of the preset track 101 and is connected to the plurality of limiting portions 51 on both sides of the preset track 101. The limiting portions 51 can be rotatably arranged such that the limiting portions 51 can roll against the side wall of the preset track 101 when the battery swapping device 100 is walking in the preset track 101. The walking maintenance mechanism 5 also includes a connecting component 53 that connects the mounting portion 52 and the first walking wheel set 21, the second walking wheel set 31, and the third walking wheel set 22, respectively. The connecting component 53 also includes a baffle 531 that extends in the walking direction of the battery swapping device 100 and has a certain height. The baffle 531 is located between the wheel 4 and the first walking frame 23 or between the wheel 4 and the second walking frame 32 to protect the wheel 4. In particular, when the locking mechanism is in an unlocked state, the battery swapping device 100 can slide relative to the second walking wheel set 31 to avoid damage to the wheel 4 when the wheel of the second walking wheel set 31 collides with the second walking frame 32 during the sliding process, thereby affecting the function of the battery swapping device. In other embodiments, the mounting portion 52 can also be directly connected to the first walking wheel set 21, the second walking wheel set 31, and the third walking wheel set 22, so as to ensure the reliability of the connection. The limiting portion 51 of the walking maintenance mechanism 5 can roll in the side wall of the preset track 101, thereby reducing the friction on the preset track 101, while ensuring the limitation on the walking of the wheels 4 of the first walking wheel set 21, the second walking wheel set 31 and the third walking wheel set 22.

In this embodiment, the mounting portion 52 includes a mounting plate 521 located above the preset track 101 and extension plates 522 extending downwards from both sides of the mounting plate 521 to both sides of the preset track 101. The extension plates 522 are configured to connect the limiting portion 51. The mounting plate 521 is provided with a wheel accommodation region 523 configured to accommodate the wheel 4 of the battery swapping device 100, such that the wheel 4 is attached to the upper surface of the preset track 101 and walks on the preset track 101. The extension plate 522 is arranged to facilitate the mounting of the limiting portion 51, and through the wheel accommodation region 523 of the mounting plate 521, the wheel 4 is conveniently attached to the surface of the preset track 101 and walks on the preset track 101, and the entire structure is more compact.

In other embodiments, the wheel 4 is a grooved wheel whose lower edges on both sides can cooperate with the preset track 101. The lower edges of the grooved wheel are engaged with the preset track 101, such that the wheel is limited to walk on the guide rail of the preset track 101. At the same time, the grooved wheel can be adopted to make the structure of the battery swapping device 100 simpler and more compact.

In this embodiment, the battery swapping device 100 also includes an electrical element 6, the electrical element 6 is configured to control the motion of the first walking module 2, the second walking module 3 and the battery swapping module 1; the electrical element 6 is partially arranged in the first walking frame 23; the battery swapping device 100 also includes an electrical frame 7, the electrical frame 7 is connected to the first walking frame 23, and the electrical element 6 is partially arranged in the electrical frame 7. The motion of the first walking module 2, the second walking module 3 and the battery swapping module 1 is controlled by the electrical element 6 to realize the automatic motion of the battery swapping device 100; since the first walking wheel set 21 does not need to be provided with a driving component, the walking frame where the first walking wheel set 21 is located can reserve a mounting region to mount part of the electrical elements 6, and the space of the first walking frame 23 can be sufficiently utilized, such that the component layout is more compact. The electrical frame 7 is arranged to facilitate the mounting of the electrical element 6 and has a certain protective effect on the electrical element 6. In other optional embodiments, the electrical element 6 can also be arranged only in the electrical frame 7 or only in the first walking frame 23.

In this embodiment, two lifting mechanisms 12 are arranged, and the two lifting mechanisms 12 are symmetrically arranged on both sides of the battery swapping platform 13 in a walking direction. When the two lifting mechanisms 12 drive the battery swapping platform 13, the two lifting mechanisms 12 can disperse the supporting force of the battery swapping platform 13, increase contact points with the battery swapping platform 13, further enhance the smoothness and stability of movement of the battery swapping platform 13 in the height direction when the battery swapping platform 13 carries the battery pack, and avoid damage to the battery pack due to uneven force on the battery swapping platform 13.

In this embodiment, the lifting mechanism 12 includes a driving assembly 121, a lifting assembly 122 and a transmission assembly 123, wherein the driving assembly 121 is arranged on the side of the partition plate 113 away from the battery swapping platform 13 and is located in the side zones 115, and is configured to provide a power to the lifting mechanism 12 to raise and lower the battery swapping platform 13; the lifting assembly 122 is arranged on the side of the partition plate 113 close to the battery swapping platform 13 and is located in the central zone 114, and is connected to the battery swapping platform 13 to drive the battery swapping platform 13 to rise and fall in the height direction of the frame body 11; and the transmission assembly 123 penetrates through the partition plate 113, and the transmission assembly 123 is connected between the driving assembly 121 and the lifting assembly 122, such that the driving assembly 121 can drive the lifting assembly 122 to rise and fall. The driving assembly 121 and the transmission assembly 123 are arranged to ensure the stability of movement of the battery swapping platform 13 driven by the lifting assembly 122. At the same time, the transmission assembly 123 is arranged between the driving assembly 121 and the lifting assembly 122, thereby ensuring the synchronization and stability of the operation of the driving assembly 121 and the lifting assembly 122, changing the operation speed of the lifting assembly 122 by adjusting the operation of the driving assembly 121, and ensuring the consistency of rising and falling of the battery swapping platform 13 adjusted through the lifting assemblies 122 on both sides.

In this embodiment, the transmission assembly 123 includes a connecting portion 1231 and a transmission portion 1232, one end of the connecting portion 1231 is sleeved on a power output shaft of the driving assembly 121, and the other end penetrates through the partition plate 113 and extends to the central zone 114. The transmission portion 1232 is located in the central zone 114 and is arranged on the partition plate 113, and the transmission portion 1232 is connected to the other end of the connecting portion 1231, such that the transmission portion 1232 can be driven by the driving assembly 121 and move forwards and backwards in a vertical walking direction. The lifting assembly 122 includes a lifting member 1221, one end of the lifting member 1221 is connected to the transmission portion 1232, the other end is connected to the battery swapping platform 13, and the transmission portion 1232 drives the lifting member 1221 during forward and backward movement in the vertical walking direction, such that the battery swapping platform 13 can rise and fall in the height direction relative to the frame body 11. By respectively arranging a connecting portion 1231 and a transmission portion 1232 which are linked to each other and can perform linear motion synchronously on the driving assembly 121 and the partition plate 113, the power conversion of the driving assembly 121 to drive the lifting assembly 122 is accurately and stably realized, and the implementation manner is more convenient and simpler. At the same time, the lifting member 1221 is arranged to achieve the smoothness and reliability of the rising and falling of the battery swapping platform 13, such that the battery swapping device 100 can rise and fall to a position suitable for disassembly and mounting of the battery to disassemble and mount the battery on the battery swapping vehicle. Further, the battery swapping platform 13 can also rise and fall to different heights to satisfy the needs of vehicle chassis of different heights and enhance applicability.

In this embodiment, the connecting portion 1231 includes a positioning structure 12311, two recessed portions 12312 and a limiting plate 12313. The positioning structure 12311 is sleeved on the power output shaft of the driving assembly 121 and is in threaded connection with the power output shaft, such that the positioning structure 12311 moves in the extension direction of the power output shaft; in the moving direction of the positioning structure 12311, the two recessed portions 12312 are symmetrically arranged on both sides of the positioning structure 12311, and accommodate the protrusions 12314 on the two corresponding sides of the positioning structure 12311. The protrusions 12314 extend in a direction away from the positioning structure 12311 without exceeding the maximum thickness of the recessed portion 12312. The partition plate 113 is provided with an opening for the limiting plate 12313 to penetrate through, the limiting plate 12313 penetrates through the opening and is slidably connected to the partition plate 113 in the moving direction of the positioning structure 12311, one end of the limiting plate 12313 is connected to the two recessed portions 12312, and the other end penetrates through the partition plate 113 and is connected to the transmission portion 1232. Through cooperation between the positioning structure 12311, the recessed portion 12312 and the limiting plate 12313, the transmission portion 1232 moves in the same direction as the positioning structure 12311, and the reliability and stability of the transmission are ensured. At the same time, the two protrusions 12314 of the positioning structure 12311 are limited and fixed by the recessed portion 12312. This concave-convex structure is limited only in the motion direction, and the degree of freedom of the positioning structure 12311 in the non-motion direction is guaranteed while achieving the transmission effect of the linear motion of the connecting portion 1231 in the extension direction of the power output shaft. At the same time, the protrusion 12314 extends away from the positioning structure 12311 and does not exceed the maximum thickness of the recessed portion 12312. This structural form also avoids the interference of the protrusion 12314 on the linear motion of the connecting portion 1231 caused when the positioning structure 12311 contacts the recessed portion 12312. Specifically, in this embodiment, one side of the recessed portion 12312 is open, and the other three sides match with the protrusion 12314. One side or both sides of the recessed portion 12312 located in the moving direction of the positioning structure 12311 can be set as a clearance matching surface with the protrusion 12314. In another embodiment, in the moving direction of the positioning structure 12311, the side wall where the protrusion 12314 contacts the recessed portion 12312 is set as an arc surface, and the arc surface takes the extension direction of the protrusion as the axis direction. Through the above structural setting, the protrusion 12314 is not completely fixed in the recessed portion 12312, and the protrusion 12314 can be conveniently mounted and disassembled without affecting the transmission performance, and can also conveniently rotate in the recessed portion 12312 and do other motions unrelated to the linear motion direction, such that the protrusion 12314 can be conveniently adjusted; and the side wall where the protrusion 12314 contacts the recessed portion 12312 adopts an arc surface structure, such that even if there is a certain deviation between the protrusion 12314 and the recessed portion 12312 in the rotation direction around the axis of the protrusion 12314 due to an assembly error, the gap between the protrusion 12314 and the recessed portion 12312 in the linear motion direction can always be kept equal, thereby reducing the assembly requirements and ensuring the consistency of transmission between the positioning structure 12311 and the transmission portion 1232.

Specifically, in this embodiment, the extension direction of the power output shaft of the driving assembly 121 is perpendicular to the walking direction of the battery swapping device 100, that is, parallel to the extension direction of the partition plate 113. A positioning structure 12311 is sleeved on the power output shaft, and the positioning structure 12311 is engaged with the recessed portion 12312 to drive the recessed portion 12312 to move, and the recessed portion 12312 is connected to one end of the limiting plate 12313, and the limiting plate 12313 penetrates through the partition plate 113, and the other end of the limiting plate 12313 is connected to a tooth block 12323, and the tooth block 12323 is cooperatively connected to the transmission portion 1232. The partition plate 113 is provided with a fourth slide rail 12316, and the recessed portion 12312 is connected to the fifth sliding block 12317 through the connecting plate 12315. The positioning structure 12311 moves more stably in the extension direction of the partition plate 113 through the cooperation between the fifth sliding block 12317 and the fourth slide rail 12316, meanwhile, the positioning structure 12311 drives the limiting plate 12313 to move, further drives the transmission portion 1232 to move, and drives the lifting mechanism 12 to rise and fall.

In this embodiment, the transmission portion 1232 includes a gear 12321 and a rack 12322 that mesh with each other. The rack 12322 is movably arranged on the partition plate 113, and the rack 12322 is engaged and fixed with the tooth block 12323 arranged at the other end of the limiting plate 12313, such that the rack 12322 can be driven by the driving assembly 121 and move forwards and backwards in the vertical walking direction. When the rack 12322 moves forwards and backwards and drives the gear 12321 to rotate, the lifting member 1221 rotates in with the gear 12321 to drive the battery swapping platform 13 to rise and fall. The accuracy of transmission is enhanced by meshing the gear 12321 and the rack 12322, and the synchronization of the operation of the gear 12321 and the driving mechanism 311 is ensured. At the same time, the rotation speed of the gear 12321 can be changed by adjusting the operation of the power output shaft of the driving mechanism 311. Further, the meshing of the gear 12321 and the rack 12322 also ensures smooth operation of the gear 12321, thereby ensuring that the battery swapping platform 13 can rise and fall smoothly. At the same time, the reliability and synchronization between the connecting portion 1231 and the transmission portion 1232 are improved by the engagement and fixation of the tooth block 12323 and the rack 12322. In another embodiment, in order to make the connection between the tooth block 12323 and the rack 12322 more reliable, through holes can be preset on the tooth block 12323 and the rack 12322 and the through holes can be connected by fasteners.

In this embodiment, two gears 12321 are arranged, the two gears 12321 are arranged in the extension direction of the rack 12322, are located at both ends of the rack 12322, and are coaxially arranged with the lifting member 1221. Two gears 12321 are arranged on one side of the battery swapping platform 13 in the vertical walking direction. When the battery swapping platform 13 is driven by the plurality of gears 12321, the force on the battery swapping platform 13 can be balanced, and the contact points with the battery swapping platform 13 are increased, thereby enhancing the smoothness and stability of movement of the battery swapping platform 13 in the height direction when the battery swapping platform 13 carries the battery pack, and avoiding damage to the battery pack due to uneven force on the battery swapping platform 13.

In this embodiment, the lifting mechanism 12 also includes guide members 124, and four guide members 124 are arranged around the battery swapping platform 13 in the length direction and the width direction of the frame body 11, to guide the battery swapping platform 13 to rise and fall. By arranging the guide members 124 on two opposite sides of the battery swapping platform 13 or around the battery swapping platform 13, the smoothness and reliability of the rising or falling of the battery swapping platform 13 are achieved, such that the battery swapping device 100 can rise and fall to a position suitable for disassembling and mounting of the battery to disassemble or mount the battery on the battery swapping vehicle. Further, the battery swapping platform 13 can also rise and fall to different heights to satisfy the needs of vehicle chassis of different heights and enhance applicability. In other optional embodiments, the number of guide members 124 is not limited to four. For example, two guide members 124 can also be arranged, and the two guide members 124 are respectively arranged on two opposite sides of the battery swapping platform 13, wherein the guide members 124 are preferably arranged on both sides of the partition plate 113 close to the battery swapping platform 13, such that the guide members 124 can cooperate with the lifting assembly 122 to further improve the stability in rising and falling.

In this embodiment, the guide member 124 includes a first connecting rod 1241 and a second connecting rod 1242 that are hinged with each other, wherein one end of the first connecting rod 1241 is rotatably connected to the frame body 11, and the other end is slidably connected to the battery swapping platform 13; one end of the second connecting rod 1242 is slidably connected to the battery swapping platform 13, and the other end is rotatably connected to the frame body 11, such that the guide member 124 can be expanded or retracted with the battery swapping platform 13 during the rising and falling process to guide the battery swapping platform 13 to rise and fall in the height direction. The above structural form enhances the flexibility of the connection of the guide member 124 to the frame body 11 and the battery swapping platform 13, such that the height by which the battery swapping platform 13 rises is adjustable, the battery swapping platform 13 can swap batteries for electric vehicles with different chassis heights, and the wide applicability of the battery swapping device 100 is further enhanced. At the same time, the overall height of the guide member 124 of this structure is relatively low, thereby being conducive to reducing the height of the entire battery swapping device 100. Since in the case of chassis-type battery swapping, the space under a vehicle is limited, the battery pack of a heavy truck is large in size, and a low-height battery swapping device 100 is required to adapt.

In this embodiment, the battery swapping platform 13 includes a support frame 131, and the support frame 131 is located at the bottom of the battery swapping platform 13. The support frame 131 is provided with a matching portion 1311 that matches the lifting mechanism 12 on a side wall facing the partition plate 113, such that the support frame 131 can be driven by the lifting mechanism 12 to rise and fall. The battery swapping platform 13 also includes a first layer plate 132 and a second layer plate 133 that are respectively located above the support frame 131 and movably connected to the support frame 131, and the first layer plate 132 is located above the second layer plate 133; the first layer plate 132 is provided with a battery positioning column 134 configured to position the battery pack on the battery swapping vehicle and an unlocking mechanism 135 configured to unlock the battery pack, wherein the unlocking mechanism 135 can play an auxiliary positioning role in a process of positioning the battery swapping device 100 and the battery pack on the electric vehicle. The second layer plate 133 is provided with a vehicle positioning column 136 configured to position the battery swapping vehicle, the second layer plate 133 is provided with an extension portion 1331 extending out of the frame body 11 in the vertical walking direction, and the vehicle positioning column 136 is arranged on the extension portion 1331 of the second layer plate 133. This structural form is adopted to further enhance the accuracy of the connection between the battery pack and the chassis of the battery swapping vehicle, improve the alignment accuracy between the battery and the bottom of the battery swapping vehicle during the battery swapping process, and ensure the tightness of the connection of the battery to the battery swapping vehicle. At the same time, only the second layer plate 133 is provided with the extension portion 1331, such that the entire battery swapping device 100 can be positioned with the battery pack with no need of increasing the size of other regions, and costs are saved. Further, through staggered arrangement of the first layer plate 132 and the second layer plate 133 in the horizontal direction and the height direction, the height difference between the first layer plate 132 and the second layer plate 133 can be further reduced, thereby lowering the entire battery swapping platform 13, and further compressing the height of the battery swapping device 100 to satisfy the minimum height requirement for battery swapping of heavy trucks. At the same time, the first layer plate 132 and the second layer plate 133 are respectively provided with battery positioning columns 134 and vehicle positioning columns 136 to correspondingly position the battery pack and the battery swapping vehicle, such that the battery swapping device 100 can be accurately positioned to the battery pack, and the battery can be effectively disassembled and mounted.

Specifically, in this embodiment, the lifting member 1221 is a cam structure, the matching portion 1311 is a sliding groove structure extending in a horizontal direction, one end of the cam structure is arranged in the sliding groove structure, the gear 12321 drives the cam structure to rotate, and the cam structure can move horizontally in the sliding groove structure, and at the same time drive the sliding groove structure to move upwards, thereby lifting the support frame 131.

In this embodiment, the support frame 131 is provided with a guide mechanism 137 and a moving mechanism 138. The guide mechanism 137 includes a guide rail 1371 in a vertical walking direction and two third sliding blocks 1372 and two fourth sliding blocks 1373 arranged on the guide rail 1371. The third sliding block 1372 is connected to the first layer plate 132, and the fourth sliding block 1373 is connected to the second layer plate 133. In the locking and unlocking directions, the two third sliding blocks 1372 are respectively arranged at the front side and the rear side of the two fourth sliding blocks 1373; and the length of the second layer plate 133 in the extension direction of the guide rail 1371 is shorter than the length of the first layer plate 132. At least one end of the second layer plate 133 in the extension direction of the guide rail 1371 is provided with an avoidance region 1332 to facilitate the connection between the first layer plate 132 and the two third sliding blocks 1372, and the moving mechanism 138 includes a first moving unit 1381 and a second moving unit 1382, wherein the first moving unit 1381 is arranged on the support frame 131, and is connected to and drives the first layer plate 132 to move in a reciprocating manner in the extension direction of the guide rail 1371; and the second moving unit 1382 is arranged on the support frame 131, and is connected to and drives the second layer plate 133 to move in a reciprocating manner in the extension direction of the guide rail 1371. The second layer plate 133 is provided with an avoidance groove 1333 for the connecting member of the first layer plate 132 to penetrate through and connect with the first moving unit 1381. The first layer plate 132 and the second layer plate 133 are simultaneously carried by the support frame 131, and the sizes of the second layer plate 133 and the first layer plate 132 are designed to be different, or the avoidance region 1332 is arranged on the second layer plate 133, such that the first layer plate 132 and the second layer plate 133 are connected to a single guide rail through different sliding blocks, the number of guide rails is effectively reduced and space is saved, and further the design requirements of the guide mechanism 137 and the first layer plate 132 and the second layer plate 133 in terms of compact structure and reduced component height are satisfied. At the same time, the first moving unit 1381 and the second moving unit 1382 that drive the first layer plate 132 and the second layer plate 133 to move on the support frame 131 are arranged side by side, and the second layer plate 133 is provided with an avoidance groove 1333 to facilitate the connection between the first layer plate 132 located above the second layer plate 133 and the first moving unit 1381, such that the connection between the moving mechanism 138 and the first layer plate 132 and the second layer plate 133 is convenient, the design requirements of compact structure and reduced component height are satisfied, and the height of the entire battery swapping device 100 is further reduced. Specifically, in this embodiment, a plurality of avoidance grooves 1333 are arranged at intervals on the second layer plate 133 in a direction perpendicular to the walking direction of the battery swapping device 100, such that a plurality of connecting members of the first layer plate 132 penetrate through these avoidance grooves 1333 and are connected with the first moving unit 1381, the avoidance regions 1332 are arranged on both sides of the second layer plate 133 perpendicular to the walking direction of the battery swapping device 100. The avoidance regions 1332 are arranged to make the second layer plate 133 narrower than the first layer plate 132 at this position, thereby reserving a space for the connection between the third sliding block 1372 and the first layer plate 132. By arranging the avoidance grooves 1333 and the avoidance regions 1332 on the second layer plate, the vertical staggered mounting and movement of the first layer plate 132 and the second layer plate 133 are realized.

In this embodiment, the transverse beam 111 includes a first region 1111 corresponding to the extension portion 1331 and second regions 1112 located on both sides of the extension portion 1331. The height of the first region 1111 is lower than the height of the second region 1112, such that when the battery swapping platform 13 is not lifted, the first layer plate 132 is lower than the second region 1112. There is a height difference between the first region 1111 and the second region 1112, such that the central zone 114 has a larger accommodation space in the height direction, thereby increasing the compression limit of the battery swapping platform 13 in the height direction, and further satisfying the minimum height requirement for battery swapping of heavy trucks.

### Embodiment 2

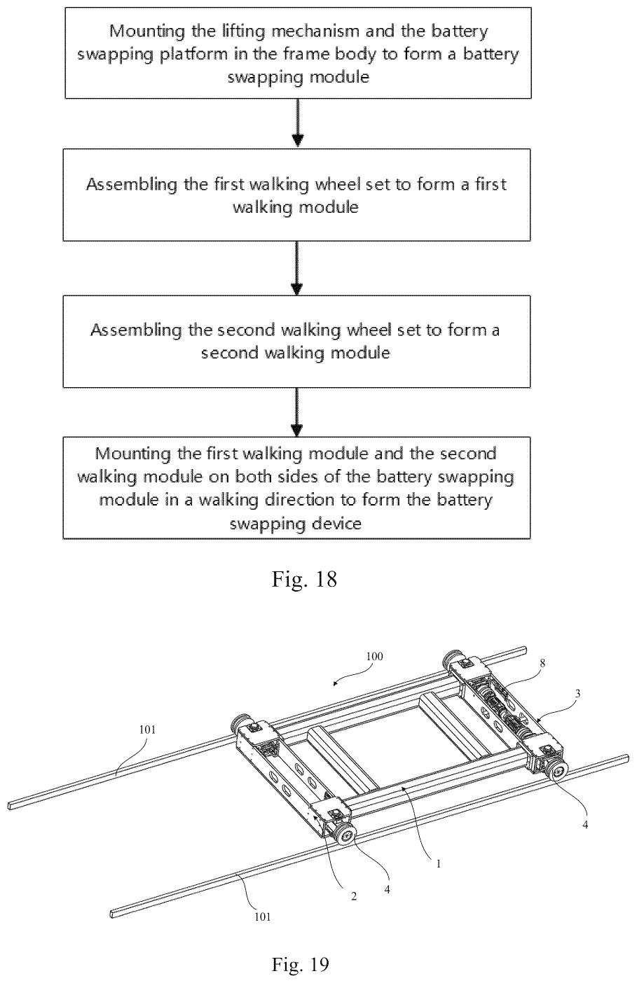

As shown in FIG. 18, this embodiment further provides an assembling method for a battery swapping device 100, and the assembling method is applicable to the battery swapping device 100 in the above Embodiment 1. The assembling method includes the following steps:
mounting the lifting mechanism 12 and the battery swapping platform 13 in the frame body 11 to form a battery swapping module 1;
assembling the first walking wheel set 21 to form a first walking module 2;
assembling the second walking wheel set 31 to form a second walking module 3; and
mounting the first walking module 2 and the second walking module 3 on both sides of the battery swapping module 1 in a walking direction to form the battery swapping device 100.

The battery swapping device 100 is assembled in a modular manner. Since the overall structure of each module is small, the modules are easily assembled; and the required corresponding mechanisms are assembled into each module respectively, to reduce the complexity of assembly and the possibility of errors. At the same time, the modules can be assembled according to the connection relationship and position relationship between the modules. The staff can assemble the modules as needed according to the actual situation, thereby enhancing the flexibility of assembling and debugging a single module. Further, after mounting the other components in the corresponding modules according to the actual situation, the modules are assembled according to the connection relationship and position relationship between the components in each module, such that the space occupied by on-site assembly before the modules are assembled can be saved.

In this embodiment, the step of mounting the lifting mechanism 12 and the battery swapping platform 13 in the frame body 11 to form the battery swapping module 1, the step of assembling the first walking wheel set 21 to form a first walking module 2, and the step of assembling the second walking wheel set 31 to form a second walking module 3 are implemented simultaneously.

By implementing the above three steps simultaneously, the efficiency in assembling the battery swapping device 100 by the staff is improved, and the modules can be assembled by multiple staff at the same time to reduce the total time consumed in assembling the battery swapping device 100 and shorten the production cycle. At the same time, when the modules have not been assembled with each other, different assembly workers can mount the corresponding mechanisms at the corresponding positions inside each module, such that subsequent assembly workers can directly assemble the modules according to the positions of the corresponding mechanisms inside each module. The mounting difficulty is relatively low, and it is easy to debug separately after the mounting is completed.

In this embodiment, the frame body 11 includes two opposing transverse beams 111 and two opposing longitudinal beams 112 arranged to enclose a space, and two partition plates 113 parallel to the longitudinal beams 112 and connected to the transverse beams 111; the partition plates 113 divide the frame module into a central zone 114 and side zones 115 symmetrically arranged on both sides of the central zone 114; the lifting mechanism 12 is connected to the partition plates 113; and the lifting mechanism 12 is partially located in the side zones 115 and partially located in the central zone 114, and the battery swapping platform 13 is arranged in the central zone 114 and connected to the lifting mechanism 12, such that the battery swapping platform 13 can be lifted by the lifting mechanism 12 and rise and fall relative to the frame body 11 to swap batteries for the battery swapping vehicle.

In the assembling method, the step of mounting the lifting mechanism 12 and the battery swapping platform 13 in the frame body 11 to form the battery swapping module 1 specifically includes the following steps:
respectively arranging the two transverse beams 111 and the two longitudinal beams 112 opposite to each other and connecting them in a surrounding manner;
arranging the two partition plates 113 parallel to the longitudinal beam 112 and connecting the two partition plates 113 to the transverse beam 111;
connecting the lifting mechanism 12 to the partition plate 113; and
arranging the battery swapping platform 13 in the central zone 114 and connecting to the lifting mechanism 12.

Two transverse beams 111 and two longitudinal beams 112 enclose a frame structure, and the frame structure is divided into regions by two partition plates 113, so as to facilitate the mounting of the lifting mechanism 12 and the battery swapping platform 13, make the structure of the battery swapping device 100 more compact and help to improve the assembly efficiency of the battery swapping device 100.

In this embodiment, the first walking module 2 further includes a third walking wheel set 22, and the first walking wheel set 21 and the third walking wheel set 22 are oppositely arranged on both sides of the battery swapping device 100 parallel to the walking direction.

In the assembling method, the step of assembling the first walking wheel set 21 to form the first walking module 2 specifically includes the following step:
mounting the third walking wheel set 22 of the first walking module 2 on a side of the battery swapping device 100 that is parallel to the walking direction and opposite to the first walking wheel set 21.

A third walking wheel set 22 is arranged in the first walking module 2, and the first walking wheel set 21 and the third walking wheel set 22 are arranged opposite to each other, thereby being beneficial to ensuring the walking smoothness of the battery swapping device 100.

In this embodiment, the two second walking wheel sets 31 are oppositely arranged on both sides of the battery swapping device 100 parallel to the walking direction.

In the assembling method, the step of assembling the second walking wheel set 31 to form the second walking module 3 specifically includes the following step:
oppositely mounting the two second walking wheel sets 31 on both sides of the battery swapping device 100 parallel to the walking direction.

The two second walking wheel sets 31 are arranged on both sides of the battery swapping device 100 parallel to the walking direction, thereby being beneficial to ensuring the walking stability of the battery swapping device 100.

In this embodiment, the two second walking wheel sets 31 are each independently provided with a driving mechanism 311.

In the assembling method, the step of assembling the second walking wheel set 31 to form the second walking module 3 specifically includes the following step:
independently mounting a driving mechanism 311 on each of the two second walking wheel sets 31.

When the two second walking wheel sets 31 are provided with a driving mechanism 311, a rotational torque can be applied to the battery swapping module 1 through the two second walking wheel sets 31, such that the battery swapping module 1 can rotate in a horizontal plane with the first walking wheel set 21 as a fulcrum, the rotational power of the battery swapping device 100 can be increased, and the application scope of the battery swapping device 100 is expanded.

In other optional embodiments, the driving mechanism 311 can be mounted in only one of the two second walking wheel sets 31. Preferably, the driving mechanism 311 is arranged in the second walking wheel set 31 located diagonally opposite to the first walking wheel set 21. In the assembling method, the step of assembling the second walking wheel set 31 to form the second walking module 3 specifically includes the following step: mounting a driving mechanism 311 in the second walking wheel set 31 located diagonally opposite to the first walking wheel set 21.

In this embodiment, the first walking module 2 further includes a first walking frame 23, and the second walking module 3 further includes a second walking frame 32. The first walking frame 23 and the second walking frame 32 are oppositely arranged on both sides of the vertical walking direction of the battery swapping module 1. The first walking wheel set 21 and the third walking wheel set 22 are respectively located on both sides of the first walking frame 23 in the walking direction, and the two second walking wheel sets 31 are respectively located on both sides of the second walking frame 32 in the walking direction.

In the assembling method, the step of assembling the first walking wheel set 21 to form the first walking module 2 further includes the following steps:
respectively mounting the first walking wheel set 21 and the third walking wheel set 22 on both sides of the first walking frame 23 in the walking direction; and
connecting the first walking frame 23 to one side of the battery swapping module 1 in a vertical walking direction; and
in the assembling method, the step of assembling the second walking wheel set 31 to form the second walking module 3 further includes the following steps:
respectively arranging the two second walking wheel sets 31 on both sides of the second walking frame 32 in the walking direction; and
connecting the second walking frame 32 to the other side of the battery swapping module 1 perpendicular to the walking direction.

The first walking module 2 and the second walking module 3 are assembled separately, and then the first walking module 2 and the second walking module 3 are arranged on both sides of the battery swapping module 1 perpendicular to the walking direction, thereby saving the space occupied by on-site assembly before the modules are assembled, and facilitating improvement of the assembly efficiency.

In this embodiment, the top and bottom of the first walking wheel set 21 are respectively connected to the first walking frame 23 through the first rotating assembly 24. The first rotating assembly 24 includes a fixed portion 241 and a rotating portion 242 that are configured to withstand a radial force and an axial force and are rotatably connected to each other, the fixed portion 241 is connected to the first walking frame 23, and the rotating portion 242 is connected to the top or bottom of the first walking wheel set 21.

In the assembling method, the step of respectively mounting the first walking wheel set 21 and the third walking wheel set 22 on both sides of the first walking frame 23 in the walking direction further includes the following steps:
mounting a first rotating assembly 24 above and below the first walking wheel set 21 respectively;
connecting the fixed portion 241 of the first rotating assembly 24 to the first walking wheel set 21; and
connecting the rotating portion 242 of the first rotating assembly 24 to the first walking frame 23.

The rotational connection between the first walking frame 23 and the first walking wheel set 21 is achieved by means of the fixed portion 241 and the rotating portion 242 that are rotatably connected to each other. At the same time, since the fixed portion 241 and the rotating portion 242 can withstand a radial force and an axial force, the stability of the rotational connection can be better, and the walking smoothness of the first walking frame 23 can be further improved.

In other optional embodiments, the rotating portion 242 can also be connected to the first walking frame 23, and the fixed portion 241 can be connected to the top or bottom of the first walking wheel set 21. In the assembling method, the step of mounting the first walking wheel set 21 and the third walking wheel set 22 on both sides of the first walking frame 23 in the walking direction further includes the following steps: mounting the first rotating assembly 24 above and below the first walking wheel set 21 respectively; connecting the rotating portion 242 of the first rotating assembly 24 to the first walking wheel set 21; and connecting the fixed portion 241 of the first rotating assembly 24 to the first walking frame 23.

In this embodiment, the front side and the rear side of the third walking wheel set 22 in the walking direction are connected to the first walking frame 23 respectively through the first sliding assembly 25, the first sliding assembly 25 includes a first slide rail 251 and a first sliding block 252 that cooperate with each other, the first slide rail 251 is connected to the first walking frame 23, and the first sliding block 252 is connected to the third walking wheel set 22, such that the third walking wheel set 22 can slide relative to the first walking frame 23 in a direction perpendicular to the walking direction; the front side and the rear side of the second walking wheel set 31 in the walking direction are connected to the second walking frame 32 respectively through the second sliding assembly 33, the second sliding assembly 33 includes a second slide rail 331 and a second sliding block 332 that cooperate with each other, the second slide rail 331 is connected to the second walking frame 32, and the second sliding block 332 is connected to the second walking wheel set 31, such that the second walking wheel set 31 can slide relative to the second walking frame 32 in a direction perpendicular to the walking direction.

In the assembling method, the step of respectively mounting the first walking wheel set 21 and the third walking wheel set 22 on both sides of the first walking frame 23 in the walking direction further includes the following steps:
mounting a first sliding assembly 25 respectively on the front side and the rear side of the third walking wheel set 22 in the walking direction; and
connecting the first slide rail 251 in the first sliding assembly 25 to the first walking frame 23, and connecting the first sliding block 252 to the third walking wheel set 22.

In the assembling method, the step of respectively mounting the two second walking wheel sets 31 on both sides of the second walking frame 32 in the walking direction further includes the following steps:
mounting a second sliding assembly 33 respectively on the front side and the rear side of the second walking wheel set 31 in the walking direction; and
connecting the second slide rail 331 of the second sliding assembly 33 to the second walking frame 32, and connecting the second sliding block 332 to the second walking wheel set 31.

The third walking wheel set 22 is slidably connected to the first walking frame 23 through the first sliding assembly 25, and the second walking wheel set 31 is slidably connected to the second walking frame 32 through the second sliding assembly 33, to provide a way to realize the displacement in the horizontal plane required for the battery swapping module 1 during rotation; and the cooperation between the first slide rail 251 and the first sliding block 252 and the cooperation between the second slide rail 331 and the second sliding block 332 make the sliding more stable.

In other optional embodiments, the first sliding block 252 can also be connected to the first walking frame 23, the first slide rail 251 can be connected to the third walking wheel set 22, the second sliding block 332 can be connected to the second walking frame 32, and the second slide rail 331 can be connected to the second walking wheel set 31. In the assembling method, the step of respectively arranging the first walking wheel set 21 and the third walking wheel set 22 on both sides of the first walking frame 23 in the walking direction further includes the following steps: respectively mounting the first sliding assembly 25 on the front side and the rear side of the third walking wheel set 22 in the walking direction; connecting the first sliding block 252 in the first sliding assembly 25 to the first walking frame 23, and connecting the first slide rail 251 to the third walking wheel set 22. In the assembling method, the step of respectively mounting the two second walking wheel sets 31 on both sides of the second walking frame 32 in the walking direction further includes the following steps: respectively mounting the second sliding assembly 33 on the front side and the rear side of the second walking wheel set 31 in the walking direction; connecting the second sliding block 332 of the second sliding assembly 33 to the second walking frame 32, and connecting the second slide rail 331 to the second walking wheel set 31.

In this embodiment, the first walking frame 23 is further internally provided with a first connecting seat 26, and the front side and the rear side of the third walking wheel set 22 are respectively connected to the first connecting seat 26 through the first sliding assembly 25, and the top and bottom of the first connecting seat 26 are respectively connected to the first walking frame 23 through the second rotating assembly 27. The second walking frame 32 is further internally provided with a second connecting seat 34, the front side and the rear side of the second walking wheel set 31 are respectively connected to the second connecting seat 34 through the second sliding assembly 33, and the top and bottom of the second connecting seat 34 are respectively connected to the second walking frame 32 through the second rotating assembly 27.

In the assembling method, the step of respectively mounting the first walking wheel set 21 and the third walking wheel set 22 on both sides of the first walking frame 23 in the walking direction further includes the following steps:
connecting the first sliding assemblies 25 at the front side and the rear side of the third walking wheel set 22 to the first connecting seat 26 respectively; and
rotatably connecting the first connecting seat 26 to the first walking frame 23 by mounting the second rotating assembly 27 above and below the first connecting seat 26.

In the assembling method, the step of respectively mounting the two second walking wheel sets 31 on both sides of the second walking frame 32 in the walking direction further includes the following steps:
connecting the second sliding assemblies 33 at the front side and the rear side of the second walking wheel set 31 to the second connecting seat 34 respectively; and
rotatably connecting the second connecting seat 34 to the second walking frame 32 by mounting the second rotating assembly 27 above and below the second connecting seat 34.

The third walking wheel set 22 can slide relative to the first connecting seat 26, the second walking wheel set 31 can slide relative to the second connecting seat 34, the first connecting seat 26 and the second connecting seat 34 can rotate relative to the first walking frame 23 and the second walking frame 32 respectively; in addition, the front side and the rear side of the third walking wheel set 22 are provided with a first sliding assembly 25, and the front side and the rear side of the second walking wheel set 31 are provided with a second sliding assembly 33, such that the third walking wheel set 22 and the second walking wheel set 31 slide more stably, and the sliding is prevented from deviating from the preset sliding trajectory.

In this embodiment, the second sliding assembly 33 is provided with a locking mechanism having a locked state and an unlocked state. When the locking mechanism is in the locked state, relative sliding of the second sliding assembly 33 can be limited, such that when the second walking wheel set 31 is driven, the battery swapping device 100 can be driven to move in the preset track 101; when the locking mechanism is in the unlocked state, the second sliding assembly 33 can slide relatively, such that when the second walking wheel set 31 is driven, the second walking wheel set 31 moves by a preset distance in the preset track 101, and can drive the battery swapping device 100 to rotate in a horizontal plane with the first walking wheel set 21 as a fulcrum, thereby realizing the alignment of the battery swapping module 1 with the battery of the battery swapping vehicle.

In the assembling method, the step of respectively mounting the two second walking wheel sets 31 on both sides of the second walking frame 32 in the walking direction further includes the following step:
mounting a locking mechanism in the second sliding assembly 33, such that when the locking mechanism is in the locked state, relative sliding of the second sliding assembly 33 can be limited; and when the locking mechanism is in the unlocked state, the second sliding assembly 33 can slide relatively.

During a process in which the battery swapping device 100 walks in the walking direction specified by the preset track 101 until the battery swapping device 100 is aligned with the battery of the battery swapping vehicle, the locking mechanism is in a locked state, that is, the second slide rail 331 and the second sliding block 332 of the second sliding assembly 33 cannot slide relative to each other, thereby preventing shaking of the battery swapping device 100 due to the sliding of the second sliding assembly 33 during an initial walking process, and improving the walking smoothness of the battery swapping device 100; after the battery swapping device 100 walks below the battery swapping vehicle, the locking mechanism is changed to an unlocked state, such that the second slide rail 331 and the second sliding block 332 can slide relative to each other, and then the relative angle between the battery swapping device 100 and the battery swapping vehicle is adjusted.

In this embodiment, the locking mechanism includes a retractable locking rod. When the locking mechanism is in a locked state, the locking rod extends from an original position and abuts against or inserts into the second slide rail 331 at a preset position to limit the relative movement between the second slide rail 331 and the second sliding block 332. When the locking mechanism is in an unlocked state, the locking rod retracts to the original position.

In the assembling method, the step of mounting the locking mechanism in the second sliding assembly 33 further includes the following step:
mounting a locking rod in the locking mechanism, such that when the locking mechanism is in a locked state, the locking rod extends from the original position and abuts against or inserts into the second slide rail 331 at a preset position to limit the relative movement of the second slide rail 331 and the second sliding block 332; and when the locking mechanism is in an unlocked state, the locking rod retracts to the original position.

The locking rod is set to be retractable, and the locking mechanism can be switched between the locked state and the unlocked state, thereby achieving the control over whether the second sliding assembly 33 can slide. When the locking rod extends and presses the second slide rail 331, the second sliding block 332 is prevented from sliding relative to the second slide rail 331 through a friction force, or the locking rod is inserted into the second slide rail 331 to further improve the reliability of limiting the sliding of the second sliding assembly 33.

In this embodiment, the extension direction of the locking rod points to the side of the second slide rail 331, and the shape of the end of the locking rod matches the shape of the side of the second slide rail 331; two locking rods are arranged, and the two locking rods are respectively arranged on the upper and lower sides of the second slide rail 331.

In the assembling method, the step of mounting the locking rod in the locking mechanism further includes the following steps:
setting the extension direction of the locking rod to point to the side of the second slide rail 331; and
respectively mounting the locking rods on the upper and lower sides of the second slide rail 331.

The two locking rods act on the second slide rail 331 from the upper and lower sides of the second slide rail 331 respectively, such that the two locking rods can clamp the second slide rail 331 during the locking process, and the friction force is greater and the locking effect is better. The shape of the end of the locking rod matches the shape of the side of the second slide rail 331, such that the locking rod and the second slide rail 331 are more firmly engaged, thereby being conducive to further improving the locking effect of the locking rod and preventing the locking rod from detaching from the second slide rail 331. In other optional embodiments, a locking hole for the locking rod to be inserted can also be formed in the second slide rail 331 for locking, and the locking effect can be further improved by the pin hole matching method of the locking rod and the locking hole.

In this embodiment, the first walking wheel set 21, the second walking wheel set 31 and the third walking wheel set 22 are all provided with wheels 4 that can walk in the preset track 101, and the wheels 4 are grooved wheels whose lower edges on both sides can cooperate with the preset track 101; or, the first walking wheel set 21, the second walking wheel set 31 and the third walking wheel set 22 are all connected to a walking maintenance mechanism 5, and the walking maintenance mechanism 5 straddles the preset track 101, such that the wheels 4 of the first walking wheel set 21, the second walking wheel set 31 and the third walking wheel set 22 are limited to walk on the preset track 101.

In the assembling method, the step of assembling the first walking wheel set 21 to form the first walking module 2 and the step of assembling the second walking wheel set 31 to form the second walking module 3 include the following steps:
mounting wheels 4 in the first walking wheel set 21, the second walking wheel set 31 and the third walking wheel set 22; and
engaging the wheels 4 with the preset track 101.

Alternatively, the first walking wheel set 21, the second walking wheel set 31 and the third walking wheel set 22 are provided with wheels that can walk in the preset track 101 and a walking maintenance mechanism 5 connected to the wheels, and the walking maintenance mechanism 5 straddles the preset track 101, such that the wheels 4 of the first walking wheel set 21, the second walking wheel set 31 and the third walking wheel set 22 are limited to walk on the preset track 101.

In the assembling method, the step of assembling the first walking wheel set 21 to form the first walking module 2 and the step of assembling the second walking wheel set 31 to form the second walking module 3 include the following steps:
mounting the wheels 4 in the first walking wheel set 21, the second walking wheel set 31 and the third walking wheel set 22;
connecting the first walking wheel set 21, the second walking wheel set 31 and the third walking wheel set 22 to the walking maintenance mechanism 5 respectively; and
straddling the walking maintenance mechanism 5 on the preset track 101.

The wheel 4 is a grooved wheel that engages with the preset track 101, making the structure of the battery swapping device 100 more compact; alternatively, the wheel is limited to the track by connecting the wheel to the walking maintenance mechanism; and any one of the above structures can be adopted to ensure that the wheels 4 of the first walking wheel set 21, the second walking wheel set 31 and the third walking wheel set 22 will not slip or deviate from the preset track 101 when moving in the preset guide rail 1371, thereby further ensuring the walking stability of the battery swapping device 100.

In this embodiment, the walking maintenance mechanism 5 includes a plurality of limiting portions 51 straddling both sides of the preset track 101 and a mounting portion 52 configured to mount the limiting portions 51. The mounting portion 52 straddles the preset track 101 in the width direction of the preset track 101 and is connected to the plurality of limiting portions 51 on both sides of the preset track 101. The limiting portions 51 are rotatably arranged such that the limiting portions 51 can roll against a side wall of the preset track 101 when the battery swapping device 100 is walking in the preset track 101.

In the assembling method, the step of enabling the walking maintenance mechanism 5 to straddle the preset track 101 further includes the following steps:
enabling the mounting portion 52 to straddle the preset track 101 in the width direction of the preset track 101 and to be connected to the plurality of limiting portions 51 on both sides of the preset track 101; and
rotatably mounting the limiting portions 51 on the side wall of the preset track 101.

The mounting portion 52 of the walking maintenance mechanism 5 is configured to connect the first walking wheel set 21, the second walking wheel set 31 and the third walking wheel set 22, thereby ensuring the reliability of the connection; the limiting portion 51 of the walking maintenance mechanism 5 can roll in the side wall of the preset track 101, thereby reducing the friction on the preset track 101, and at the same time ensuring the limitation on the walking of the wheels 4 of the first walking wheel set 21, the second walking wheel set 31 and the third walking wheel set 22.

In this embodiment, the mounting portion 52 includes a mounting plate 521 located above the preset track 101 and extension plates 522 extending downwards from both sides of the mounting plate 521 to both sides of the preset track 101, the extension plates 522 are configured to connect the limiting portion 51, and the mounting plate 521 is provided with a wheel accommodation region 523 for accommodating the wheels 4 of the battery swapping device 100, such that the wheels 4 are attached to the upper surface of the preset track 101 and walk on the preset track 101.

In the assembling method, the step of enabling the walking maintenance mechanism 5 to straddle the preset track 101 further includes the following steps:
connecting the mounting plate 521 to the first walking wheel set 21, the second walking wheel set 31 or the third walking wheel set 22; and
connecting the extension plate 522 to the limiting portion 51.

The extension plate 522 is arranged to facilitate the mounting of the limiting portion 51, through the wheel accommodation region 523 of the mounting plate 521, the wheel 4 is easily attached to the surface of the preset track 101 and easily walks on the preset track 101, and the entire structure is more compact.

In this embodiment, the battery swapping device 100 further includes an electrical element 6, the electrical element 6 is configured to control the motion of the first walking module 2, the second walking module 3 and the battery swapping module 1; the electrical element 6 is partially arranged in the first walking frame 23; the battery swapping device 100 further includes an electrical frame 7, the electrical frame 7 is connected to the first walking frame 23, and the electrical element 6 is partially arranged in the electrical frame 7.

In the assembling method, the following steps are performed after assembling the first walking wheel set 21 to form the first walking module 2:
mounting at least part of the electrical elements 6 in the first walking frame 23; and
connecting the electrical frame 7 to the first walking frame 23, and mounting part of the electrical elements 6 in the electrical frame 7.

When the electrical element 6 is mounted in the first walking frame 23 and the electrical frame 7, the structure is compact and the mounting is simple and convenient, moreover, the first walking frame 23 and the electrical frame 7 have a certain protective effect on the electrical element 6.

In this embodiment, two lifting mechanisms 12 are arranged, and the two lifting mechanisms 12 are symmetrically arranged on both sides of the battery swapping platform 13 in the walking direction.

In the assembling method, the step of mounting the lifting mechanism 12 and the battery swapping platform 13 in the frame body 11 to form the battery swapping module 1 includes the following step:
symmetrically mounting the two lifting mechanisms 12 on both sides of the battery swapping platform 13 in the walking direction.

The two lifting mechanisms 12 can be simultaneously arranged on both sides of the battery swapping platform 13 to improve the assembly efficiency. When the two lifting mechanisms 12 drive the battery swapping platform 13, the two lifting mechanisms 12 can disperse the supporting force of the battery swapping platform 13, increase contact points with the battery swapping platform 13, further enhance the smoothness and stability of movement of the battery swapping platform 13 in the height direction when the battery swapping platform 13 carries the battery pack, and avoid damage to the battery pack due to uneven force on the battery swapping platform 13.

In this embodiment, the lifting mechanism 12 includes a driving assembly 121, a lifting assembly 122 and a transmission assembly 123, wherein the driving assembly 121 is arranged on the side of the partition plate 113 away from the battery swapping platform 13 and is located in the side zones 115, and is configured to provide a power to the lifting mechanism 12 to raise and lower the battery swapping platform 13; the lifting assembly 122 is arranged on the side of the partition plate 113 close to the battery swapping platform 13 and is located in the central zone 114, and is connected to the battery swapping platform 13 to drive the battery swapping platform 13 to rise and fall in the height direction of the frame body 11; and the transmission assembly 123 penetrates through the partition plate 113, and the transmission assembly 123 is connected between the driving assembly 121 and the lifting assembly 122, such that the driving assembly 121 can drive the lifting assembly 122 to rise and fall.

In the assembling method, the step of mounting the lifting mechanism 12 and the battery swapping platform 13 in the frame body 11 to form the battery swapping module 1 further includes the following steps:
mounting the driving assembly 121 on a side of the partition plate 113 away from the battery swapping platform 13 and within the side zones 115;
mounting the lifting assembly 122 on a side of the partition plate 113 close to the battery swapping platform 13 and within the central zone 114, and connecting the lifting assembly 122 to the battery swapping platform 13; and
enabling the transmission assembly 123 to penetrate through the partition plate 113 and connecting the transmission assembly 123 between the driving assembly 121 and the lifting assembly 122.

The driving assembly 121 provides power for the lifting mechanism 12 to raise and lower the battery swapping platform 13, and the lifting assembly 122 drives the battery swapping platform 13 to rise and fall in the height direction of the frame body 11. The transmission assembly 123 enables the driving assembly 121 to drive the lifting assembly 122 to rise and fall. The above structure is mounted to allow the battery swapping platform 13 to move the battery pack smoothly.

In this embodiment, the transmission assembly 123 includes a connecting portion 1231 and a transmission portion 1232, wherein one end of the connecting portion 1231 is sleeved on the power output shaft of the driving assembly 121, and the other end penetrates through the partition plate 113 and extends to the central zone 114; the transmission portion 1232 is located in the central zone 114 and is arranged on the partition plate 113, and the transmission portion 1232 is connected to the other end of the connecting portion 1231, such that the transmission portion 1232 can be driven by the driving assembly 121 to move forwards and backwards in the vertical walking direction; and the lifting assembly 122 includes a lifting member 1221, one end of the lifting member 1221 is connected to the transmission portion 1232, and the other end is connected to the battery swapping platform 13, and the transmission portion 1232 drives the lifting member 1221 during the forward and backward movement in the vertical walking direction, such that the battery swapping platform 13 can rise and fall in the height direction relative to the frame body 11.

In the assembling method, the step of mounting the lifting mechanism 12 and the battery swapping platform 13 in the frame body 11 to form the battery swapping module 1 further includes the following steps:
enabling one end of the connecting portion 1231 to be sleeved on the power output shaft of the driving assembly 121, and enabling the other end to penetrate through the partition plate 113 and extend to the central zone 114;
arranging the transmission portion 1232 in the central zone 114 and mounting on the partition plate 113, and connecting to the other end of the connecting portion 1231; and
connecting one end of the lifting member 1221 to the transmission portion 1232, and connecting the other end to the battery swapping platform 13.

By respectively arranging a connecting portion 1231 and a transmission portion 1232 which are linked to each other and can perform linear motion synchronously on the driving assembly 121 and the partition plate 113, the power conversion of the driving assembly 121 to drive the lifting assembly 122 is accurately and stably realized. The lifting assembly 1221 is arranged to achieve the smoothness and reliability of the rising and falling of the battery swapping platform 13.

In this embodiment, the connecting portion 1231 includes a positioning structure 12311, two recessed portions 12312 and a limiting plate 12313. The positioning structure 12311 is sleeved on the power output shaft of the driving assembly 121 and is in threaded connection with the power output shaft, such that the positioning structure 12311 moves in the extension direction of the power output shaft; in the moving direction of the positioning structure 12311, the two recessed portions 12312 are symmetrically arranged on both sides of the positioning structure 12311, and accommodate the protrusions 12314 on the two corresponding sides of the positioning structure 12311, and the protrusions 12314 extend in a direction away from the positioning structure 12311 without exceeding the maximum thickness of the recessed portion 12312. The limiting plate 12313 is located on the side of the connecting portion 1231 close to the transmission portion 1232 and is slidably connected to the partition plate 113 in the moving direction of the positioning structure 12311, one end of the limiting plate 12313 is connected to the two recessed portions 12312, and the other end penetrates through the partition plate 113 and is connected to the transmission portion 1232.

In the assembling method, the step of enabling one end of the connecting portion 1231 to be sleeved on the power output shaft of the driving assembly 121 and enabling the other end to penetrate through the partition plate 113 and extend to the central zone 114 specifically includes the following steps:
enabling the positioning structure 12311 to be sleeved on the power output shaft of the driving assembly 121 and to be in threaded connection with the power output shaft;
symmetrically arranging the two recessed portions 12312 on both sides of the positioning structure 12311, and assembling with the gap between the protrusions 12314 on the two corresponding sides of the positioning structure 12311; and
slidably mounting the limiting plate 12313 on the partition plate 113 and on the side of the connecting portion 1231 close to the transmission portion 1232, connecting one end of the limiting plate 12313 to the two recessed portions 12312, and enabling the other end to penetrate through the partition plate 113 and to be connected to the transmission portion 1232.

Through cooperation between the positioning structure 12311, the recessed portion 12312 and the limiting plate 12313, the transmission portion 1232 moves in the same direction as the positioning structure 12311, and the reliability and stability of transmission are ensured. The recessed portion 12312 is arranged to limit and fix two protrusions 12314 of the positioning structure 12311, this concave-convex structure only limits in the motion direction, and the transmission effect of the linear motion of the connecting portion 1231 in the extension direction of the power output shaft is achieved, while the degree of freedom of the positioning structure 12311 in the non-motion direction is guaranteed.

In this embodiment, the transmission portion 1232 includes a gear 12321 and a rack 12322 that mesh with each other. The rack 12322 is movably arranged on the partition plate 113, and the rack 12322 is engaged and fixed with a tooth block arranged at the other end of the limiting plate 12313, such that the rack 12322 can be driven by the driving assembly 121 to move forwards and backwards in the vertical walking direction. When the rack 12322 moves forwards and backwards and drives the gear 12321 to rotate, the lifting member 1221 rotates in with the gear 12321 to drive the battery swapping platform 13 to rise and fall.

In the assembling method, the step of arranging the transmission portion 1232 in the central zone 114 and mounting the transmission portion 1232 on the partition plate 113, and connecting the transmission portion 1232 to the other end of the connecting portion 1231 specifically includes the following steps:
movably mounting the rack 12322 on the partition plate 113, mounting a tooth block 12323 to the other end of the limiting plate 12313, and engaging and fixing the tooth block 12323 with the rack 12322; and
mounting the gear 12321 on the lifting member 1221 and meshing the gear 12321 with the rack 12322.

The rack 12322 is engaged with the tooth block, such that the rack 12322 can be driven by the driving assembly 121 to move forwards and backwards in the vertical walking direction, thereby driving the gear 12321 to rotate, and then driving the lifting member 1221 to move through the gear 12321, further driving the battery swapping platform 13 to rise and fall, and ensuring the rising and lowering stability of the battery swapping platform 13.

In this embodiment, two gears 12321 are arranged, and the two gears 12321 are arranged in the extension direction of the rack 12322 and are located at both ends of the rack 12322 and are coaxially arranged with the lifting member 1221.

In the assembling method, the step of meshing the gear 12321 with the rack 12322 and connecting the gear 12321 with the lifting member 1221 further includes the following steps:
coaxially mounting the two gears 12321 with the lifting member 1221 respectively;
placing the two gears 12321 at both ends in the extension direction of the rack 12322 and meshing the two gears 12321 with the rack 12322.

Two gears 12321 are arranged on one side of the battery swapping platform 13 in the vertical walking direction. When the battery swapping platform 13 is driven by the plurality of gears 12321, the force on the battery swapping platform 13 can be balanced, and the contact points with the battery swapping platform 13 are increased, thereby enhancing the smoothness and stability of movement of the battery swapping platform 13 in the height direction when the battery swapping platform 13 carries the battery pack, and avoiding damage to the battery pack due to uneven force on the battery swapping platform 13.

In this embodiment, the lifting mechanism 12 further includes guide members 124, and at least two guide members 124 are arranged on the peripheral side of the battery swapping platform 13 in the length direction and/or the width direction of the frame body 11, to guide the battery swapping platform 13 to rise and fall.

In the assembling method, the step of mounting the lifting mechanism 12 and the battery swapping platform 13 in the frame body 11 to form the battery swapping module 1 further includes the following step:
arranging the guide members 124 on the peripheral side of the battery swapping platform 13 in the length direction and/or the width direction of the frame body 11.

By arranging guide members 124 on the two opposite sides of the battery swapping platform 13 or around the battery swapping platform 13, the smoothness and reliability of the rising and falling of the battery swapping platform 13 are achieved, such that the battery swapping device 100 can rise and fall to a position suitable for disassembly and mounting of the battery to disassemble and mount the battery on the battery swapping vehicle.

In this embodiment, the guide member 124 includes a first connecting rod 1241 and a second connecting rod 1242 that are hinged to each other, wherein one end of the first connecting rod 1241 is rotatably connected to the frame body 11, and the other end is slidably connected to the battery swapping platform 13; one end of the second connecting rod 1242 is slidably connected to the battery swapping platform 13, and the other end is rotatably connected to the frame body 11, such that the guide member 124 can be expanded or retracted with the battery swapping platform 13 during the rising and falling process to guide the battery swapping platform 13 to rise and fall in the height direction.

In the assembling method, the step of arranging the guide member 124 on the peripheral side of the battery swapping platform 13 in the length direction and/or the width direction of the frame body 11 further includes the following steps:
enabling the first connecting rod 1241 to be hinged to the second connecting rod 1242;
rotatably connecting one end of the first connecting rod 1241 to the frame body 11, and slidably connecting the other end to the battery swapping platform 13; and
slidably connecting one end of the second connecting rod 1242 to the battery swapping platform 13, and rotatably connecting the other end to the frame body 11.

The above structural form enhances the flexibility of connecting the guide member 124 to the frame body 11 and the battery swapping platform 13, such that the height by which the battery swapping platform 13 rises is adjustable, thereby satisfying the battery swapping platform 13 for battery swapping of electric vehicles with different chassis heights, and further enhancing the wide applicability of the battery swapping device 100.

In this embodiment, the battery swapping platform 13 includes a support frame 131, and the support frame 131 is located at the bottom of the battery swapping platform 13. The support frame 131 is provided with a matching portion 1311 that matches the lifting mechanism 12 on a side wall facing the partition plate 113, such that the support frame 131 can be driven by the lifting mechanism 12 to rise and fall. The battery swapping platform 13 also includes a first layer plate 132 and a second layer plate 133 that are respectively located above the support frame 131 and movably connected to the support frame 131, and the first layer plate 132 is located above the second layer plate 133; the first layer plate 132 is provided with a battery positioning column 134 configured to position the battery pack on a battery swapping vehicle and an unlocking mechanism 135 configured to unlock the battery pack, wherein the second layer plate 133 is provided with a vehicle positioning column 136 configured to position the battery swapping vehicle, the second layer plate 133 is provided with an extension portion 1331 extending out of the frame body 11 in the vertical walking direction, and the vehicle positioning column 136 is arranged on the extension portion 1331 of the second layer plate 133.

In the assembling method, the step of mounting the lifting mechanism 12 and the battery swapping platform 13 in the frame body 11 to form the battery swapping module 1 further includes the following steps:
connecting the second layer plate 133 to the support frame 131; and
connecting the first layer plate 132 to the support frame 131 and enabling the first layer plate 132 to be located above the second layer plate 133.

Through staggered arrangement of the upper layer plate and the lower layer plate in the horizontal direction, the height difference between the upper layer plate and the lower layer plate can be further reduced, the compressibility and adjustability of the distance between the upper layer plate and the lower layer plate can be achieved, and the purpose of lowering the height of the entire battery swapping module is achieved, such that the height of the battery swapping device 100 is further compressed, to satisfy the height requirements of battery swapping of heavy-duty trucks for adapting to different vehicle chassis and the minimum height requirement on the vehicle chassis.

In this embodiment, the support frame 131 is provided with a guide mechanism 137 and a moving mechanism 138. The guide mechanism 137 includes a guide rail 1371 in a vertical walking direction and two third sliding blocks 1372 and two fourth sliding blocks 1373 arranged on the guide rail 1371. The third sliding block 1372 is connected to the first layer plate 132, and the fourth sliding block 1373 is connected to the second layer plate 133. In the locking and unlocking directions, the two third sliding blocks 1372 are respectively arranged at the front side and the rear side of the two fourth sliding blocks 1373; the length of the second layer plate 133 in the extension direction of the guide rail 1371 is shorter than the length of the first layer plate 132. At least one end of the second layer plate 133 in the extension direction of the guide rail 1371 is provided with an avoidance region 1332 to facilitate the connection between the first layer plate 132 and the two third sliding blocks 1372, and the moving mechanism 138 includes a first moving unit 1381 and a second moving unit 1382, wherein the first moving unit 1381 is arranged on the support frame 131, and is connected to and drives the first layer plate 132 to move in a reciprocating manner in the extension direction of the guide rail 1371; and the second moving unit 1382 is arranged on the support frame 131, and is connected to and drives the second layer plate 133 to move in a reciprocating manner in the extension direction of the guide rail 1371. The second layer plate 133 is provided with an avoidance groove 1333 for the connecting member of the first layer plate 132 to penetrate through and connect with the first moving unit 1381.

In the assembling method, the step of mounting the lifting mechanism 12 and the battery swapping platform 13 in the frame body 11 to form the battery swapping module 1 further includes the following steps:
mounting two third sliding blocks 1372 and two fourth sliding blocks 1373 on the guide rail 1371, and connecting the fourth sliding block 1373 to the second layer plate 133;
in the locking and unlocking directions, respectively mounting the two third sliding blocks 1372 on the front side and the rear side of the two fourth sliding blocks 1373 and enabling the two third sliding blocks 1372 to be located in the avoidance region 1332 of the second layer plate 133 or on the front side and the rear side of the second layer plate 133, and connecting the third sliding blocks 1372 to the first layer plate 132; and
arranging the second moving unit 1382 on the support frame 131 and connecting the second moving unit 1382 to the second layer plate 133.

The first moving unit 1381 is arranged on the support frame 131, and the connecting member of the first layer plate 132 penetrates through the avoidance groove of the second layer plate 133 and is connected to the first moving unit 1381.

The first layer plate 132 and the second layer plate 133 are simultaneously carried by the support frame 131, and the size of the second layer plate 133 is different from the size of the first layer plate 132, or the second layer plate 133 is provided with an avoidance region 1332, such that the first layer plate 132 and the second layer plate 133 are connected to the guide rails respectively without interfering with each other, thereby improving the assembly efficiency. Meanwhile, the second layer plate 133 is provided with an avoidance groove 1333, such that the first layer plate 132 and the second layer plate 133 are connected to the corresponding moving units respectively, thereby preventing mutual interference with each other, improving assembly efficiency and the structural compactness after assembly.

### Embodiment 3

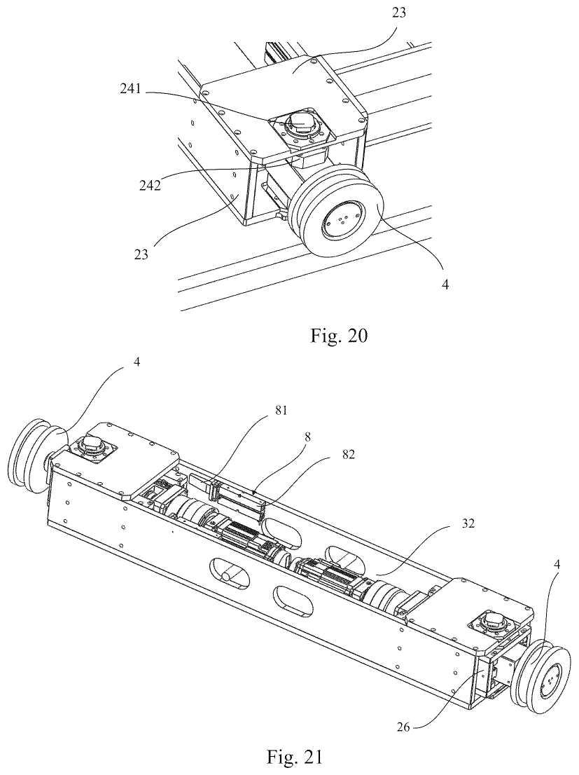

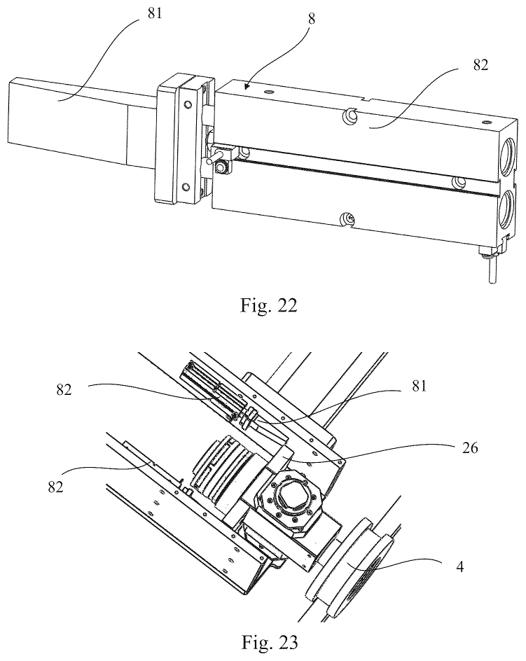

This embodiment provides a battery swapping device 100, the battery swapping device 100 is generally similar in structure to the battery swapping device 100 in Embodiment 1, except that a stopping assembly 8 is arranged in the first walking frame 23, as described below in conjunction with FIGS. 19 to 22. The stopping assembly 8 is arranged between the first walking frame 23 and the first connecting seat 26; a stopping assembly 8 is arranged in the second walking frame 32, and the stopping assembly 8 is arranged between the second walking frame 32 and the second connecting seat 34; the stopping assembly 8 has a locked state and an unlocked state to lock or unlock the relative rotation state between the first walking frame 23 and the first connecting seat 26 or the relative rotation state between the second walking frame 32 and the second connecting seat 34, respectively. The first connecting seat 26 can lock its relative position with the first walking frame 23 through the stopping assembly 8 when the battery swapping device 100 moves, thereby preventing the first walking wheel set 21 and the third walking wheel set 22 from rotating. The second connecting seat can lock its relative position with the second walking frame 32 through the stopping assembly 8 when the battery swapping device 100 moves, such that the second walking wheel set 31 is prevented from rotating, and the battery swapping device 100 moves more smoothly and will not shake due to rotation. When the battery swapping device 100 needs to adjust its posture to align with the electric vehicle, the first connecting seat 26 and the second connecting seat 34 can move relative to the first walking frame 23 and the second walking frame 32 by unlocking the stopping assembly 8, such that the battery swapping device 100 can be relatively twisted to align with the battery swapping vehicle, and the battery is easily disassembled and mounted.

Specifically, in this embodiment, a first connecting seat 26 is also arranged between the first walking wheel set 21 and the first walking frame 23 in the first walking module 2. The first connecting seat 26 can adopt the same structure as the first connecting seat 26 in the second walking wheel set and the third walking wheel set. Alternatively, as shown in FIG. 23, the first connecting seat 26 is a plate-shaped member. When the first walking wheel set does not need a sliding function, the first connecting seat 26 is simpler in structure, and is conveniently processed and mounted. Moreover, the first gap between the first connecting seat 26 and the first walking frame 23 can be smaller, thereby being further beneficial to reducing the size of the wedge-shaped block 81. The first connecting seat 26 connected to the third walking wheel set 22 in the first walking module 2 and the second connecting seat 34 connected to the second walking wheel set 31 in the second walking module 3 are both arranged to be frame shaped, such that the first sliding assembly and the second sliding assembly are conveniently set. In other optional embodiments, a plate-shaped member can also be arranged separately between the third walking wheel set 22 and the first walking frame 23 and between the second walking wheel set 31 and the second walking frame 32.

In this embodiment, a first gap is formed between the first connecting seat 26 and the first walking frame 23 on the front side and the rear side in the walking direction, and a second gap is formed between the second connecting seat 34 and the second walking frame 32 on the front side and the rear side in the walking direction. The stopping assembly 8 includes a retractable wedge-shaped block 81. When the stopping assembly 8 is in a locked state, the wedge-shaped block 81 extends from its original position into the first gap to limit the relative rotation between the first connecting seat 26 and the first walking frame 23; and/or, the wedge-shaped block 81 extends from its original position into the second gap to limit the relative rotation between the second connecting seat 34 and the second walking frame 32. When the stopping assembly 8 is in an unlocked state, the wedge-shaped block 81 retracts to its original position to release the first gap and the second gap. A first gap is formed between the first connecting seat 26 and the first walking frame 23, and a second gap is formed between the second connecting seat 34 and the second walking frame 32. The first gap and the second gap can allow for the freedom of rotation. The stopping assembly 8 is arranged at the front side and the rear side of the first connecting seat 26 and the second connecting seat 34, and adopts a retractable wedge-shaped block 81, whose narrower end faces the first gap or the second gap. In the locked state, the wedge-shaped block 81 extends and is clamped into the first gap or the second gap, such that there is no freedom of rotation between the first connecting seat 26 and the first walking frame 23 and between the second connecting seat 34 and the second walking frame 32, making rotation impossible. In the unlocked state, the wedge-shaped block 81 retracts to the original position to release the first gap or the second gap, the first connecting seat 26 can rotate relative to the first walking frame 23, and the second connecting seat 34 can rotate relative to the second walking frame 32. Specifically, in this embodiment, the stopping assembly 8 also includes a cylinder 82, and the cylinder 82 pushes and pulls the wedge-shaped block 81 to realize the extension and retraction movement of the wedge-shaped block 81. In other optional embodiments, the cylinder can be replaced by other power members. In addition, in other embodiments, the first gap can be formed only between the first connecting seat 26 and the first walking frame 23, or the second gap can be formed only between the second connecting seat 34 and the second walking frame 32.

### Embodiment 4

This embodiment provides an assembling method for a battery swapping device 100, the method is applicable to the above Embodiment 3, and the method is substantially the same as the method in Embodiment 2, and the main difference lies in the mounting of the stopping assembly 8, which is described in detail below:

In this embodiment, the stopping assembly 8 is arranged in the first walking frame 23, and the stopping assembly 8 is arranged between the first walking frame 23 and the first connecting seat 26; the stopping assembly 8 is arranged in the second walking frame 32, and the stopping assembly 8 is arranged between the second walking frame 32 and the second connecting seat 34. The stopping assembly 8 has a locked state and an unlocked state to respectively lock or unlock the relative rotation state between the first walking frame 23 and the first connecting seat 26 or the relative rotation state between the second walking frame 32 and the second connecting seat 34.

In the assembling method, the step of respectively mounting the first walking wheel set and the third walking wheel set on both sides of the first walking frame 23 in the walking direction further includes the following steps:
mounting the stopping assembly 8 between the first walking frame 23 and the first connecting seat 26; and
mounting the stopping assembly 8 between the second walking frame 32 and the second connecting seat 34.

The first connecting seat 26 or the second connecting seat 34 can lock its relative position with the first walking frame 23 or the second walking frame 32 through the stopping assembly 8 when the battery swapping device 100 moves, thereby preventing rotational movement, making the battery swapping device 100 more stable when moving and avoiding shaking due to rotation. When the battery swapping device 100 needs to adjust its posture to align with the electric vehicle, the first connecting seat 26 and the second connecting seat 34 can move relative to the first walking frame 23 and the second walking frame 32 by unlocking the stopping assembly 8, such that the battery swapping device 100 can be relatively twisted to align with the battery swapping vehicle, and the battery is conveniently dissembled and mounted.

In this embodiment, a first gap is formed between the first connecting seat 26 and the first walking frame 23 at the front side and the rear side in the walking direction, and a second gap is formed between the second connecting seat 34 and the second walking frame 32 at the front side and the rear side in the walking direction; the stopping assembly 8 includes a retractable wedge-shaped block, and when the stopping assembly 8 is in a locked state, the wedge-shaped block extends from an original position into the first gap or the second gap to limit the relative rotation between the first connecting seat 26 and the first walking frame 23; at the same time, the wedge-shaped block extends from an original position into the second gap to limit the relative rotation between the second connecting seat 34 and the second walking frame 32, and when the stopping assembly 8 is in an unlocked state, the wedge-shaped block retracts to the original position to release the first gap and the second gap.

In the assembling method, the step of mounting the stopping assembly 8 between the first walking frame 23 and the first connecting seat 26 specifically includes the following steps:
mounting the stopping assembly 8 at the first gap between the first connecting seat 26 and the first walking frame 23 at the front side and the rear side in the walking direction respectively; and
mounting the stopping assembly 8 at the second gap between the second connecting seat 34 and the second walking frame 32 at the front side and the rear side in the walking direction.

A first gap is formed between the first connecting seat 26 and the first walking frame 23, and a second gap is formed between the second connecting seat 34 and the second walking frame 32. The first gap and the second gap can allow for the freedom of rotation. The stopping assembly 8 is arranged at the front side and the rear side of the first connecting seat 26 and the second connecting seat 34, and adopts a retractable wedge-shaped block, whose narrower end faces the first gap or the second gap. In the locked state, the wedge-shaped block extends and is clamped into the first gap or the second gap, such that there is no freedom of rotation between the first connecting seat 26 and the first walking frame 23 and between the second connecting seat 34 and the second walking frame 32, making rotation impossible. In the unlocked state, the wedge-shaped block retracts to the original position to release the first gap or the second gap, and the first connecting seat 26 can rotate relative to the first walking frame 23, and the second connecting seat 34 can rotate relative to the second walking frame 32. In addition, in other embodiments, the first gap can be formed only between the first connecting seat 26 and the first walking frame 23, or the second gap can be formed only between the second connecting seat 34 and the second walking frame 32.

Although the specific embodiments of the present disclosure are described above, it should be understood by those skilled in the art that this is only for illustration and the protection scope of the present disclosure is defined by the appended claims. Those skilled in the art may make various changes or modifications to these embodiments without departing from the principles and essence of the present disclosure, but these changes and modifications shall all fall within the protection scope of the present disclosure.

1. A battery swapping device capable of walking in a preset track to perform chassis-type battery swapping for a battery swapping vehicle, wherein the battery swapping device comprises:
a battery swapping module comprising a frame body, a lifting mechanism and a battery swapping platform, wherein the frame body includes two opposing transverse beams and two opposing longitudinal beams arranged to enclose a space, and two partition plates parallel to the longitudinal beams and connected to the transverse beams, the partition plates divide the frame body into a central zone and side zones symmetrically arranged on both sides of the central zone, the lifting mechanism is connected to the partition plates, the lifting mechanism is partially located in the side zones and partially located in the central zone, and the battery swapping platform is arranged in the central zone and connected to the lifting mechanism, such that the battery swapping platform can be lifted by the lifting mechanism and rise and fall relative to the frame body to swap batteries for the battery swapping vehicle;
a first walking module connected to a side of the battery swapping module in the walking direction of the battery swapping device, wherein the first walking module includes at least one first walking wheel set that is rotatably connected; and
a second walking module connected to the other side of the battery swapping module in the walking direction and opposite to the first walking module, wherein the second walking module includes at least two second walking wheel sets that are slidably connected;
wherein when the second walking wheel set is driven, the battery swapping module can rotate in a horizontal plane with the first walking wheel set as a fulcrum to align with the battery of the battery swapping vehicle.

2. The battery swapping device according to claim 1, wherein the first walking module further comprises a third walking wheel set, and the first walking wheel set and the third walking wheel set are oppositely arranged on both sides of the battery swapping device parallel to the walking direction.

3. The battery swapping device according to claim 2, wherein the two second walking wheel sets are oppositely arranged on both sides of the battery swapping device parallel to the walking direction.

4. The battery swapping device according to claim 3, wherein a driving mechanism is mounted in one of the two second walking wheel sets, and the second walking wheel set provided with the driving mechanism is located diagonally opposite to the first walking wheel set; and/or, the two second walking wheel sets are independently provided with a driving mechanism.

5. The battery swapping device according to claim 4, wherein the first walking module also comprises a first walking frame, and the second walking module also comprises a second walking frame, the first walking frame and the second walking frame are oppositely arranged on both sides of the battery swapping module perpendicular to the walking direction, the first walking wheel set and the third walking wheel set are respectively located on both sides of the first walking frame in the walking direction, and the two second walking wheel sets are respectively located on both sides of the second walking frame in the walking direction.

6. The battery swapping device according to claim 5, wherein the top and bottom of the first walking wheel set are respectively connected to the first walking frame through a first rotating assembly, the first rotating assembly includes a fixed portion and a rotating portion that are configured to withstand a radial force and an axial force and are rotatably connected to each other, one of the fixed portion and the rotating portion is connected to the first walking frame, and the other is connected to the top or bottom of the first walking wheel set.

7. The battery swapping device according to claim 6, wherein the front side and the rear side of the third walking wheel set in the walking direction are respectively connected to the first walking frame through a first sliding assembly, the first sliding assembly includes a first slide rail and a first sliding block that cooperate with each other, one of the first slide rail and the first sliding block is connected to the first walking frame, and the other is connected to the third walking wheel set, such that the third walking wheel set can slide relative to the first walking frame in a direction perpendicular to the walking direction; and/or the front side and the rear side of the second walking wheel set in the walking direction are respectively connected to the second walking frame through a second sliding assembly, the second sliding assembly includes a second slide rail and a second sliding block that cooperate with each other, one of the second slide rail and the second sliding block is connected to the second walking frame, and the other is connected to the second walking wheel set, such that the second walking wheel set can slide relative to the second walking frame in a direction perpendicular to the walking direction.

8. The battery swapping device according to claim 7, wherein a first connecting seat is also arranged in the first walking frame, the front side and the rear side of the third walking wheel set are respectively connected to the first connecting seat through the first sliding assembly, and the top and bottom of the first connecting seat are respectively connected to the first walking frame through a second rotating assembly; and/or, a second connecting seat is also arranged in the second walking frame, the front side and the rear side of the second walking wheel set are respectively connected to the second connecting seat through the second sliding assembly, and the top and bottom of the second connecting seat are respectively connected to the second walking frame through the second rotating assembly.

9. The battery swapping device according to claim 8, wherein a locking mechanism having a locked state and an unlocked state is arranged on the second sliding assembly, when the locking mechanism is in the locked state, the locking mechanism can limit the relative sliding of the second sliding assembly, such that when the second walking wheel set is driven, the second walking wheel set can drive the battery swapping device to walk in the preset track; when the locking mechanism is in the unlocked state, the second sliding assembly can slide relatively, such that when the second walking wheel set is driven, the second walking wheel set moves by a preset distance in the preset track, and can drive the battery swapping device to rotate in a horizontal plane with the first walking wheel set as a fulcrum, such that the battery swapping module is aligned with the battery of the battery swapping vehicle;
preferably, the locking mechanism includes a retractable locking rod, when the locking mechanism is in a locked state, the locking rod extends from an original position and abuts against or is inserted into the second slide rail at a preset position to limit the relative movement of the second slide rail and the second sliding block, and when the locking mechanism is in an unlocked state, the locking rod retracts to the original position;
preferably, the telescopic direction of the locking rod points to a side of the second slide rail, and the shape of the end of the locking rod matches the shape of the side of the second slide rail, or a locking hole for the locking rod to be inserted is formed in the second slide rail; and/or, two locking rods are arranged, and the two locking rods are respectively arranged on the upper and lower sides of the second slide rail.

10. The battery swapping device according to claim 8, wherein a stopping assembly is arranged in the first walking frame, the stopping assembly is arranged between the first walking frame and the first connecting seat, and/or a stopping assembly is arranged in the second walking frame, and the stopping assembly is arranged between the second walking frame and the second connecting seat;
the stopping assembly has a locked state and an unlocked state to lock or unlock the relative rotation state between the first walking frame and the first connecting seat or the relative rotation state between the second walking frame and the second connecting seat, respectively;
preferably, a first gap is formed between the first connecting seat and the first walking frame on the front side and the rear side in the walking direction, and/or a second gap is formed between the second connecting seat and the second walking frame on the front side and the rear side in the walking direction; and
the stopping assembly includes a retractable wedge-shaped block, when the stopping assembly is in a locked state, the wedge-shaped block extends from its original position into the first gap to limit the relative rotation between the first connecting seat and the first walking frame; and/or, the wedge-shaped block extends from its original position into the second gap to limit the relative rotation between the second connecting seat and the second walking frame, and when the stopping assembly is in an unlocked state, the wedge-shaped block retracts to its original position to release the first gap and/or the second gap.

11. The battery swapping device according to claim 2, wherein the first walking wheel set, the second walking wheel set and the third walking wheel set are all provided with wheels that can walk in the preset track, and the wheels are grooved wheels whose lower edges on both sides can cooperate with the preset track; or, the first walking wheel set, the second walking wheel set and the third walking wheel set are all connected to a walking maintenance mechanism, and the walking maintenance mechanism straddles the preset track, such that the wheels of the first walking wheel set, the second walking wheel set and the third walking wheel set are limited to walk on the preset track.

12. The battery swapping device according to claim 11, wherein the walking maintenance mechanism comprises a plurality of limiting portions straddling both sides of the preset track and a mounting portion configured to mount the limiting portions, the mounting portion straddles the preset track in the width direction of the preset track and is connected to the plurality of limiting portions on both sides of the preset track, and the limiting portions are rotatably arranged such that the limiting portions can roll against the side wall of the preset track when the battery swapping device is walking in the preset track;
preferably, the mounting portion includes a mounting plate located above the preset track and extension plates extending downwards from both sides of the mounting plate to both sides of the preset track, wherein the extension plates are configured to connect the limiting portion, and the mounting plate is provided with a wheel accommodation region configured to accommodate the wheel of the battery swapping device, such that the wheel is attached to the upper surface of the preset track and walks on the preset track.

13. The battery swapping device according to claim 1, wherein two lifting mechanisms are arranged, and the two lifting mechanisms are symmetrically arranged on both sides of the battery swapping platform in the walking direction;
preferably, the lifting mechanism includes:
a driving assembly arranged on the side of the partition plate away from the battery swapping platform and located in the side zones, and configured to provide a power to the lifting mechanism to raise and lower the battery swapping platform;
a lifting assembly arranged on the side of the partition plate close to the battery swapping platform and located in the central zone, and connected to the battery swapping platform to drive the battery swapping platform to rise and fall in the height direction of the frame body; and
a transmission assembly penetrating through the partition plate and connected between the driving assembly and the lifting assembly, such that the driving assembly can drive the lifting assembly to rise and fall.

14. The battery swapping device according to claim 13, wherein
the transmission assembly includes:
a connecting portion, wherein one end of the connecting portion is sleeved on a power output shaft of the driving assembly, and the other end penetrates through the partition plate and extends to the central zone; and
a transmission portion located in the central zone and arranged on the partition plate, wherein the transmission portion is connected to the other end of the connecting portion, such that the transmission portion can be driven by the driving assembly and can move forwards and backwards in a vertical walking direction; and
the lifting assembly includes:
a lifting member, wherein one end of the lifting member is connected to the transmission portion, the other end is connected to the battery swapping platform, and the transmission portion drives the lifting member during the forward and backward movement in the vertical walking direction, such that the battery swapping platform can rise and fall in the height direction relative to the frame body.

15. The battery swapping device according to claim 14, wherein the connecting portion comprises:
a positioning structure sleeved on the power output shaft of the driving assembly and in threaded connection with the power output shaft, such that the positioning structure moves in the extension direction of the power output shaft;
two recessed portions symmetrically arranged on both sides of the positioning structure in the moving direction of the positioning structure, and accommodating the protrusions on the two corresponding sides of the positioning structure, wherein the protrusions extend in a direction away from the positioning structure without exceeding the maximum thickness of the recessed portion; and
a limiting plate located on a side of the connecting portion close to the transmission portion and slidably connected to the partition plate in the moving direction of the positioning structure, wherein one end of the limiting plate is connected to the two recessed portions, and the other end penetrates through the partition plate and is connected to the transmission portion; and
preferably, in the moving direction of the positioning structure, at least one side of the protrusion is in clearance fit with the recessed portion; and/or, in the moving direction of the positioning structure, the side wall where the protrusion contacts the recessed portion is set as an arc surface, and the arc surface takes the extension direction of the protrusion as the axial direction.

16. The battery swapping device according to claim 15, wherein the transmission portion includes a gear and a rack that mesh with each other, the rack is movably arranged on the partition plate, and the rack is engaged and fixed with the tooth block arranged at the other end of the limiting plate, such that the rack can be driven by the driving assembly and can move forwards and backwards in the vertical walking direction; and when the rack moves forwards and backwards and drives the gear to rotate, the lifting member rotates in with the gear to drive the battery swapping platform to rise and fall; and
preferably, two gears are arranged, and the two gears are arranged in the extension direction of the rack, are located at both ends of the rack, and are coaxially arranged with the lifting member.

17. The battery swapping device according to claim 13, wherein the lifting mechanism further comprises:
guide members, wherein at least two guide members are arranged on the peripheral sides of the battery swapping platform in the length direction and/or the width direction of the frame body, to guide the battery swapping platform to rise and fall, and the guide member includes a first connecting rod and a second connecting rod that are hinged with each other;
one end of the first connecting rod is rotatably connected to the frame body, and the other end is slidably connected to the battery swapping platform; and
one end of the second connecting rod is slidably connected to the battery swapping platform, and the other end is rotatably connected to the frame body, such that the guide member can be expanded or retracted with the battery swapping platform during the rising and falling process to guide the battery swapping platform to rise and fall in the height direction.

18. The battery swapping device according to claim 1, wherein the battery swapping platform comprises:
a support frame located at the bottom of the battery swapping platform, wherein the support frame is provided with a matching portion that matches the lifting mechanism on a side wall facing the partition plate, such that the support frame can be driven by the lifting mechanism to rise and fall; and
a first layer plate and a second layer plate that are respectively located above the support frame and movably connected to the support frame, wherein the first layer plate is located above the second layer plate; wherein
the first layer plate is provided with a battery positioning column configured to position the battery pack on the battery swapping vehicle and an unlocking mechanism configured to unlock the battery pack; and
the second layer plate is provided with a vehicle positioning column configured to position the battery swapping vehicle, the second layer plate is provided with an extension portion extending out of the frame body in the vertical walking direction, and the vehicle positioning column is arranged on the extension portion of the second layer plate.

19. The battery swapping device according to claim 18, wherein the support frame is provided with a guide mechanism and a moving mechanism, the guide mechanism includes a guide rail in a vertical walking direction and two third sliding blocks and two fourth sliding blocks arranged on the guide rail, the third sliding block is connected to the first layer plate, the fourth sliding block is connected to the second layer plate, and in the locking and unlocking directions, the two third sliding blocks are respectively arranged at the front side and the rear side of the two fourth sliding blocks;
the length of the second layer plate in the extension direction of the guide rail is shorter than the length of the first layer plate, or at least one end of the second layer plate in the extension direction of the guide rail is provided with an avoidance region to facilitate the connection between the first layer plate and the two third sliding blocks,
the moving mechanism includes:
a first moving unit arranged on the support frame, wherein the first moving unit is connected to and drives the first layer plate to move in a reciprocating manner in the extension direction of the guide rail;
a second moving unit arranged on the support frame, wherein the second moving unit is connected to and drives the second layer plate to move in a reciprocating manner in the extension direction of the guide rail;
the second layer plate is provided with an avoidance groove for the connecting member of the first layer plate to penetrate through and connect with the first moving unit; and
preferably, the transverse beam includes a first region corresponding to the extension portion and second regions located on both sides of the extension portion, the height of the first region is lower than the height of the second region, such that when the battery swapping platform is not lifted, the first layer plate is lower than the second region.

20. An assembling method for a battery swapping device, wherein the assembling method is applicable to the battery swapping device in claim 1, and the assembling method comprises the following steps:
mounting the lifting mechanism and the battery swapping platform in the frame body to form a battery swapping module;
assembling the first walking wheel set to form a first walking module;
assembling the second walking wheel set to form a second walking module; and
respectively mounting the first walking module and the second walking module on both sides of the battery swapping module in a walking direction to form the battery swapping device.
